(19) United States
(12) Patent Application Publication
(10) Pub. No.: US 2025/0379363 A1
(43) Pub. Date: Dec. 11, 2025

(54) ANTENNA ELEMENT, ANTENNA SYSTEM, AND COMMUNICATION DEVICE

(71) Applicant: HUAWEI TECHNOLOGIES CO., LTD., Shenzhen (CN)

(72) Inventors: Jinsong Lv, Shanghai (CN); WEI LIU, Singapore (SG); Ruolei Xu, Singapore (SG); Peng Luo, Singapore (SG); Weihong Xiao, Dongguan (CN)

(21) Appl. No.: 19/307,297

(22) Filed: Aug. 22, 2025

Related U.S. Application Data
(63) Continuation of application No. PCT/CN2024/076218, filed on Feb. 6, 2024.

(30) Foreign Application Priority Data
Feb. 23, 2023 (CN) 202310203599.8
Jan. 31, 2024 (CN) 202410142513.X

(51) Int. Cl. H01Q 9/04; H01Q 1/24

(52) U.S. Cl. CPC H01Q 9/0478; H01Q 1/246; H01Q 9/0414

(57) ABSTRACT

This application provides an antenna element, including a radiating structure, where the radiating structure includes a first conductive structure, a conductive layer, and a radiative metasurface, the first conductive structure surrounds at least a part of an edge of the conductive layer and is connected to the conductive layer, the radiative metasurface and the conductive layer are stacked, the radiative metasurface is located on a side that is of the first conductive structure and that faces away from the conductive layer, there is a first gap between the radiative metasurface and the first conductive structure, the radiative metasurface includes a plurality of conductive units, and there is a second gap between every two adjacent conductive units. This application further provides an antenna system including the antenna element and a communication device. The solutions of this application can improve cross polarization discrimination of an antenna.

### CROSS-REFERENCE TO RELATED APPLICATIONS

This application is a continuation of International Application No. PCT/CN2024/076218, filed on Feb. 6, 2024, which claims priority to Chinese Patent Application No. 202310203599.8, filed on Feb. 23, 2023 and Chinese Patent Application No. 202410142513.X, filed on Jan. 31, 2024. All of the aforementioned patent applications are hereby incorporated by reference in their entireties.

### TECHNICAL FIELD

This application relates to the field of antenna technologies, and in particular, to an antenna element, an antenna system, and a communication device.

### BACKGROUND

Asymmetric antennas may independently adjust and control horizontal and vertical beam widths in a horizontal direction and a vertical direction, to simplify a feed network, reduce a feed loss, and improve overall antenna efficiency. Therefore, the asymmetric antennas have high value in modern wireless communication systems. However, conventional asymmetric antennas have poor cross polarization discrimination (XPD), which affects antenna performance.

### SUMMARY

This application provides an antenna element, an antenna system, and a communication device, to improve cross polarization discrimination of an antenna and improve antenna performance.

According to a first aspect, this application provides an antenna element, including a radiating structure, where the radiating structure includes a first conductive structure, a conductive layer, and a radiative metasurface, the first conductive structure surrounds at least a part of an edge of the conductive layer and is connected to the conductive layer, the radiative metasurface and the conductive layer are stacked, the radiative metasurface is located on a side that is of the first conductive structure and that faces away from the conductive layer, there is a first gap between the radiative metasurface and the first conductive structure, the radiative metasurface includes a plurality of conductive units, and there is a second gap between every two adjacent conductive units.

In this solution, each antenna element can radiate and receive an electromagnetic wave. The antenna element may further include a feed structure, and the feed structure may excite the radiating structure, so that the radiating structure radiates an electromagnetic wave through the first gap and the second gap. The first conductive structure and the conductive layer may form a back cavity, and the back cavity may provide a short-circuit boundary condition for the radiative metasurface, to restrict an operating mode of the antenna element. The first gap can be designed to adjust and control cross polarization discrimination of the antenna element, so that the antenna element has good cross polarization discrimination, and radiation performance is improved. The solution in this embodiment of this application can improve cross polarization discrimination for both asymmetric antenna elements and symmetric antenna elements.

In an implementation of the first aspect, the first conductive structure surrounds the edge of the conductive layer once. The first conductive structure may surround all areas at the edge of the conductive layer, and the back cavity formed in this way may meet a product requirement, and further help ensure structural performance of the antenna element.

In an implementation of the first aspect, the first conductive structure is provided with at least one notch. The notch provided on the first conductive structure may avoid other components (for example, a connecting piece such as a screw) in the antenna element, to facilitate mounting of these components. The back cavity formed in this way may also meet the product requirement. Therefore, in this implementation, both structural performance and radiation performance of the antenna element can be considered.

In an implementation of the first aspect, the antenna includes a first dielectric layer, the first dielectric layer and the conductive layer are stacked, the first conductive structure is in contact with the first dielectric layer, or the first conductive structure is disposed in the first dielectric layer, and the radiative metasurface is located on a surface of the first dielectric layer, or the radiative metasurface is embedded in the first dielectric layer. In this solution, the radiative metasurface is loaded on the first dielectric layer, so that the radiating structure that combines the back cavity and the radiative metasurface and meets a design requirement can be designed, to help improve cross polarization discrimination.

In an implementation of the first aspect, the first dielectric layer is a physical material layer. The physical material layer is used to load the radiative metasurface, so that the antenna element can have good mass production and mechanical reliability, to help ensure radiation performance of the antenna element.

In an implementation of the first aspect, the first conductive structure and the conductive layer are connected to form a conductive frame body, the first conductive structure is a peripheral side wall of the conductive frame body, and the first dielectric layer is mounted on the first conductive structure. In this solution, the back cavity may be manufactured in a mechanical machining manner (for example, a profile machining manner), and the first dielectric layer and the radiative metasurface on the first dielectric layer may be mounted on the first conductive structure in an assembly manner. The solution can meet a product manufacturing requirement.

In an implementation of the first aspect, the first dielectric layer is located at an inner periphery of the first conductive structure, or the first dielectric layer is mounted at an end that is of the first conductive structure and that faces away from the conductive layer. This solution provides different assembly manners of the first dielectric layer and the first conductive structure, to meet product design and manufacturing requirements.

In an implementation of the first aspect, the radiative metasurface is located on a surface that is of the first dielectric layer and that faces away from the conductive layer, or the radiative metasurface is embedded in the first dielectric layer, the plurality of conductive units include a first conductive unit, a first conductive via is provided in the first dielectric layer, the first conductive via is electrically connected to the first conductive unit, the radiating structure includes a first conductive column, the first conductive column is located between the first dielectric layer and the conductive layer, and the first conductive column is electrically connected to both the first conductive via and the conductive layer; or the radiative metasurface is located on a surface that is of the first dielectric layer and that faces the conductive layer, the plurality of conductive units include a first conductive unit, the radiating structure includes a first conductive column, the first conductive column is located between the radiative metasurface and the conductive layer, and the first conductive column is electrically connected to both the first conductive unit and the conductive layer.

In this solution, the radiative metasurface is disposed at different positions of the first dielectric layer, so that different design requirements can be met. The first conductive unit in the radiative metasurface is electrically connected to the conductive layer, an antenna gain can be increased, and isolation can be further increased.

In an implementation of the first aspect, the plurality of conductive units include a plurality of edge conductive units and a plurality of internal conductive units, the plurality of edge conductive units surround an outer periphery of the plurality of internal conductive units, and the first conductive unit is the internal conductive unit. The internal conductive unit in the radiative metasurface is electrically connected to the conductive layer, so that an overall boundary condition of the radiating structure can be ensured.

In an implementation of the first aspect, the radiating structure includes a conductive frame, the conductive frame and the conductive layer are respectively located on two opposite sides of the first dielectric layer, the conductive frame surrounds at least a part of an edge of the radiative metasurface, there is a gap between the conductive frame and the radiative metasurface, the first conductive structure includes a plurality of second conductive vias formed in the first dielectric layer, and each second conductive via is electrically connected between the conductive frame and the conductive layer. In this solution, an integrated molding process (such as a PCB process) may be used to manufacture the back cavity and the radiative metasurface, so that a product manufacturing requirement can be met.

In an implementation of the first aspect, a third conductive via is provided in the first dielectric layer, the plurality of conductive units include a first conductive unit, and the first conductive unit is electrically connected to the conductive layer through the third conductive via. The first conductive unit in the radiative metasurface is electrically connected to the conductive layer, an antenna gain can be increased, and isolation can be further increased.

In an implementation of the first aspect, the plurality of conductive units include a plurality of edge conductive units and a plurality of internal conductive units, the plurality of edge conductive units surround an outer periphery of the plurality of internal conductive units, and the first conductive unit is the internal conductive unit. The internal conductive unit in the radiative metasurface is electrically connected to the conductive layer, so that an overall boundary condition of the radiating structure can be ensured.

In an implementation of the first aspect, the first dielectric layer is air. In this way, air exists between the radiative metasurface and the conductive layer, to reduce a loss and help ensure radiation performance of the antenna element.

In an implementation of the first aspect, the first conductive structure and the conductive layer are connected to form a conductive frame body, the first conductive structure is a peripheral side wall of the conductive frame body, the radiating structure includes a plurality of first support columns, each first support column is located between one conductive unit and the conductive layer, and each conductive unit is connected to at least one first support column.

In this solution, the back cavity may be manufactured in the mechanical machining manner (for example, the profile machining manner), so that the product manufacturing requirement can be met. In the solution, the radiative metasurface is supported on the conductive layer through the first support column. Therefore, when the first dielectric layer is air, a reliable connection between the radiative metasurface and the back cavity can be implemented, so that the antenna element can have good mass production and mechanical reliability, to help ensure radiation performance of the antenna element.

In an implementation of the first aspect, the radiating structure includes a ground plane, the ground plane is located between the radiative metasurface and the conductive layer, and the ground plane has a coupling slot; the conductive layer has a through hole, an orthographic projection of the coupling slot on the conductive layer falls into the through hole, the antenna element includes a feed structure, the feed structure is located outside the conductive frame body, and an orthographic projection of the feed structure on the conductive layer falls into the through hole; and each first support column is connected between one conductive unit and the ground plane.

In this solution, the ground plane, the conductive layer, and the feed structure are designed, so that the radiating structure is excited in a slot feeding manner. The radiative metasurface is supported on the ground plane through the first support column. Therefore, when the first dielectric layer is air, reliable assembly between the radiative metasurface and the back cavity can be implemented, so that the antenna element can have good mass production and mechanical reliability, to help ensure radiation performance of the antenna element.

In an implementation of the first aspect, at least one of the plurality of first support columns is conductive. In this solution, the at least one first support column is conductive, so that at least one conductive unit in the radiative metasurface can be electrically connected to the conductive layer or the ground plane, to increase the antenna gain and further increase isolation.

In an implementation of the first aspect, the plurality of conductive units include a plurality of edge conductive units and a plurality of internal conductive units, the plurality of edge conductive units surround an outer periphery of the plurality of internal conductive units, and at least one internal conductive unit is connected to the first support column that is conductive. The internal conductive unit in the radiative metasurface is electrically connected to the conductive layer or the ground plane, so that an overall boundary condition of the radiating structure can be ensured.

In an implementation of the first aspect, the radiating structure includes a conductive frame and a plurality of second support columns, the conductive frame surrounds an outer periphery of the radiative metasurface, there is a gap between the conductive frame and the radiative metasurface, each second support column is connected between one conductive unit and the conductive layer, and each conductive unit is connected to at least one second support column; and the first conductive structure includes a plurality of second conductive columns that are spaced in sequence, and each second conductive column is connected between the conductive frame and the conductive layer.

In this solution, the back cavity may be constructed by using the conductive frame, the second conductive column, and the conductive layer, and the radiative metasurface may be supported on the conductive layer through the second support column. Therefore, when the first dielectric layer is air, a reliable connection between the radiative metasurface and the back cavity can be implemented, so that the antenna element can have good mass production and mechanical reliability, to help ensure radiation performance of the antenna element.

In an implementation of the first aspect, at least one of the plurality of second support columns is conductive. In this solution, the at least one second support column is conductive, so that at least one conductive unit in the radiative metasurface can be electrically connected to the conductive layer, to increase the antenna gain and further increase isolation.

In an implementation of the first aspect, the plurality of conductive units include a plurality of edge conductive units and a plurality of internal conductive units, the plurality of edge conductive units surround an outer periphery of the plurality of internal conductive units, and at least one internal conductive unit is connected to the second support column that is conductive. The internal conductive unit in the radiative metasurface is electrically connected to the conductive layer, so that an overall boundary condition of the radiating structure can be ensured.

In an implementation of the first aspect, the antenna element includes the feed structure, a part of the feed structure is located in space enclosed by the first conductive structure and the conductive layer, at least a part of a port of the feed structure is located on a side that is of the conductive layer and that faces away from the radiative metasurface, and the feed structure is configured to excite the radiating structure. A feeding design and an antenna element design that meet a design requirement can be obtained by designing a relative position between the feed structure and the back cavity. The feed structure in this solution may be, for example, a probe feed structure, a dipole feed structure, or a patch feed structure.

In an implementation of the first aspect, the radiative metasurface has a first size in a first direction and a second size in a second direction, the first direction is perpendicular to the second direction, and the first size is greater than or equal to the second size. The first size is greater than or equal to the second size, so that the antenna element may be an asymmetric antenna or a symmetric antenna. The asymmetric antenna may independently adjust and control beam widths in a horizontal direction and a vertical direction, which helps increase the antenna gain, simplify a feed network, reduce a feed loss, and improve overall antenna efficiency. In addition, for the asymmetric antenna element, a smaller second size facilitates a compact antenna array design in the horizontal direction.

In an implementation of the first aspect, the antenna element includes a plurality of feed structures, and each feed structure is configured to excite the radiating structure. The plurality of feed structures are designed, so that an excitation area can be increased, and an excitation effect of the feed structure can be ensured.

According to a second aspect, this application provides an antenna system, including a filter circuit and the antenna element in any one of the foregoing implementations, where the filter circuit is electrically connected to the antenna element.

In this solution, an operating frequency band of the antenna element may be wide, and interference caused by a signal of another frequency band to a signal of a target frequency band may be eliminated through filtering processing of the filter circuit. For example, the filter circuit may have a high-selectivity band-pass filtering characteristic. The filter circuit may be integrated into an antenna circuit, or may be a separately designed circuit that has a filtering function. The filter circuit may be, for example, a filter. In the solution, the antenna element is applied to the antenna system, so that cross polarization discrimination of the antenna system can be improved, a horizontal beam width and a vertical beam width are adjustable to achieve a high gain, a feed network is simplified to improve overall efficiency of the antenna system, a self-decoupling function is implemented to increase isolation between antenna elements and reduce radiation pattern distortion, and a low-profile broadband can be implemented.

In an implementation of the second aspect, there are a plurality of antenna elements, the plurality of antenna elements are arranged in an array to form an array antenna, and each antenna element is electrically connected to the filter circuit. In this solution, because the radiative metasurface has an electromagnetic band gap characteristic for a surface wave, surface wave propagation in an operating frequency band of an antenna can be suppressed, to suppress antenna mutual coupling caused by surface wave propagation, and implement an antenna self-decoupling function. Therefore, after the plurality of antenna elements are arranged in the array to form the array antenna, isolation between antenna elements in the antenna array is low, distortion of a radiation pattern is small, and wireless network performance is improved.

In an implementation of the second aspect, the antenna system is a base station antenna, the base station antenna includes a radome, and both the array antenna and the filter circuit are located in the radome. This solution may be applied to the base station antenna, to improve cross polarization discrimination of the base station antenna and improve performance of the base station antenna.

In an implementation of the second aspect, a side that is of the radiative metasurface of each antenna element and that faces away from the conductive layer is connected to an inner wall of the radome, or the radiative metasurface of each antenna element is embedded between an inner surface and an outer surface of the radome, and the inner wall of the radome serves as the first dielectric layer.

In this solution, the radiative metasurface and the radome are integrated, so that the radiative metasurface can be effectively arranged by using structural space of the radome, to improve structural utilization and simplify an antenna structure. Because the radome may serve as the first dielectric layer, the first dielectric layer does not need to be additionally designed. In this way, a thickness of the antenna can be reduced, and a low-profile antenna can be implemented.

According to a third aspect, this application provides a communication device, including the antenna system in any one of the foregoing implementations. In this solution, the antenna system may be applied to a plurality of communication devices, to improve antenna performance of the communication devices.

### BRIEF DESCRIPTION OF DRAWINGS

FIG. 1 shows an application scenario in which a base station performs wireless communication with a terminal;

FIG. 2 shows an assembled structure of a base station according to an embodiment of this application;

FIG. 3 shows an internal framework structure of a part of the base station in FIG. 2;

FIG. 4 is a diagram of an assembled structure of an antenna element according to Embodiment 1;

FIG. 5a is a diagram of a disassembled structure of the antenna element in FIG. 4;

FIG. 5b is a diagram of a structure of a conductive frame body in an implementation of Embodiment 1;

FIG. 5c is a diagram of a structure of a conductive frame body in another implementation of Embodiment 1;

FIG. 6 is a diagram of a structure of a feed structure in FIG. 5a;

FIG. 7 is a diagram of an assembled structure of the antenna element in FIG. 4 from another angle of view;

FIG. 8 is a diagram of a structure of a radiative metasurface structure according to Embodiment 1;

FIG. 9 is a diagram of a partially enlarged structure at a position A in FIG. 4;

FIG. 10 is a sectional view of a structure of the antenna element in FIG. 4;

FIG. 11 is a sectional view of a structure of an antenna element in another implementation;

FIG. 12 is a sectional view of a structure of an antenna element in another implementation;

FIG. 13 is a sectional view of a structure of an antenna element in another implementation;

FIG. 14 is a top view of a structure of the antenna element in FIG. 4;

FIG. 15 is a diagram of a change in a first size and a second size of an antenna element according to an embodiment of this application;

FIG. 16 is a diagram of a structure of an antenna array formed by antenna elements according to Embodiment 1;

FIG. 17 to FIG. 32 are diagrams of performance simulation results of an antenna according to an embodiment of this application;

FIG. 33 is a sectional view of a structure of an antenna element according to Embodiment 2;

FIG. 34 is a sectional view of a structure of an antenna element in an implementation of Embodiment 3;

FIG. 35 is a sectional view of a structure of an antenna element in another implementation of Embodiment 3;

FIG. 36 is a diagram of an assembled structure of an antenna element according to Embodiment 4;

FIG. 37a is a diagram of a disassembled structure of the antenna element in FIG. 36;

FIG. 37b is a diagram of a conductive frame, a radiative metasurface, and a first dielectric layer in another implementation of Embodiment 4;

FIG. 38 is a top view of a structure of a relationship among a conductive frame, a radiative metasurface, and a first dielectric layer according to Embodiment 4;

FIG. 39 is a top view of a structure of a conductive layer according to Embodiment 4;

FIG. 40 is a top view of a structure of a feed line according to Embodiment 4;

FIG. 41 is a top view of a structure of a relationship among a conductive layer, a third dielectric layer, a feed line, a second dielectric layer, and a ground plane according to Embodiment 4;

FIG. 42 is a top view of a partial structure of a feed structure according to an embodiment;

FIG. 43 is a diagram of a partially enlarged structure at a position B in FIG. 42;

FIG. 44 is a diagram of an S parameter simulation result of an antenna element using the feed structure shown in FIG. 42;

FIG. 45 is a top view of a partial structure of a feed structure according to another embodiment;

FIG. 46 is a top view of a partial structure of a feed structure according to another embodiment;

FIG. 47 is a top view of a partial structure of a feed structure according to another embodiment;

FIG. 48 is a diagram of a structure of a feed structure of an antenna element according to Embodiment 5;

FIG. 49 is a diagram of a structure of a radiating structure of an antenna element according to Embodiment 6; and

FIG. 50 to FIG. 52 are sectional views of assembled structures of a radiating structure in different implementations of Embodiment 6.

### REFERENCE NUMERALS

1—base station; 11—pole; 12—pole support; 13—radome; 14—antenna array; 15—radio frequency processing unit; 16—cable; 17—baseband processing unit; 18—feed network; 181—phase shifter; 182—power divider; 183—filter;
2—antenna element; 21—conductive frame body; 21a—first conductive structure; 21b—conductive layer; 21c to 21g—notch; 22—radiative metasurface structure; 22a—gap; 22b—gap; 221—first dielectric layer; 222—radiative metasurface; 222a—edge conductive unit; 222b—internal conductive unit; 23—feed structure; 231—first probe; 231a—first part; 231b—second part; 232—first feed port; 233—second probe; 233a—first part; 233b—second part; 234—second feed port;
3—antenna array; 422—radiative metasurface; 44—first support column; 51—radome; 51a—first cover; 51b—second cover; 6—antenna element; 61—radiative metasurface;
7—antenna element; 7a—gap; 71—back cavity; 711—conductive frame; 711a and 711b—notch; 712—first dielectric layer; 712a—second conductive via; 712b—third conductive via; 712c—notch; 713—conductive layer; 713a—first coupling slot; 713c—part; 713d—part; 713b—second coupling slot; 713e—first coupling slot; 713f—second coupling slot; 713g—first coupling slot; 713h—second coupling slot; 72—radiative metasurface; 721—edge conductive unit; 722—internal conductive unit; 73—feed structure; 731—third dielectric layer; 731a—conductive via; 732—second dielectric layer; 732a—conductive via; 733—feed line; 733a—first feed line; 733b—second feed line; 733c—50-ohm strip line; 733d—quarter impedance converter; 733e—bent strip line; 733f—first feed line; 733g—second feed line; 833—feed line; 833a—first feed line; 833b—second feed line;
91—radiating structure; 92—radiative metasurface structure; 921—first dielectric layer; 922—radiative metasurface; 93—ground plane; 931a—first coupling slot; 931b—second coupling slot; 94—conductive frame body; 94a—through hole; 941—first conductive structure; 942—conductive layer.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

An embodiment of this application provides a communication device. The communication device includes but is not limited to a base station, a radar, a switch, a router, a gateway, a server, a network interface card, a wireless access point, a modem, an optical transceiver, an optical fiber transceiver, a mobile phone, a tablet computer, a notebook computer, a wearable device (such as smart glasses, a smart band, a smart watch, or a wireless headset), and the like. The communication device has an antenna system. The following uses a base station as an example for description.

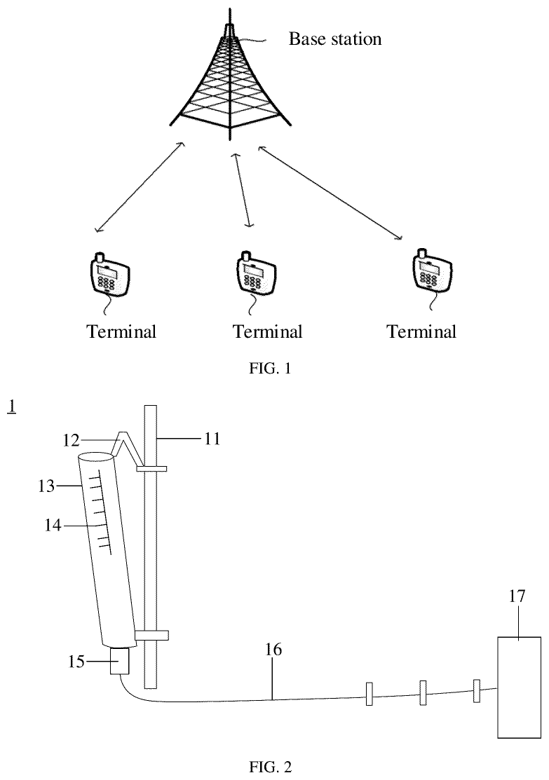

FIG. 1 shows an application scenario in which a base station performs wireless communication with a terminal. As shown in FIG. 1, the base station is configured to perform cell coverage of a radio signal, to implement communication between a terminal device and a wireless network. Specifically, the base station may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB) in a long term evolution (LTE) system, or may be a radio controller in a cloud radio access network (CRAN) scenario. Alternatively, the base station may be a relay station, an access point, a vehicle-mounted device, a wearable device, a g node (gNodeB or gNB) in a new radio (NR) system, a base station in a future evolved network, or the like. This is not limited in embodiments of this application.

The base station is equipped with a base station antenna (which belongs to an antenna system) to implement signal transmission in space. FIG. 2 shows structural composition of a base station antenna equipped for the base station in FIG. 1. As shown in FIG. 2, the base station 1 may include a pole 11, a pole support 12, a radome 13, an antenna array 14, a radio frequency processing unit 15, a cable 16, and a baseband processing unit 17. The pole support 12, the radome 13, and the antenna array 14 (or referred to as an array antenna) may be components of the base station antenna, and the base station antenna may further include a feed network, a reflection panel, and the like to be described below.

The pole 11 may be fastened to the ground. The pole support 12 is connected to the pole 11 and the radome 13, and the radome 13 is fastened to the pole 11 through the pole support 12. The antenna array 14 may be mounted in the radome 13. The feed network may be further mounted in the radome 13. The radome 13 has a good electromagnetic wave penetration characteristic and weatherability, and can protect components mounted in the radome 13.

The antenna array 14 is configured to radiate and receive antenna signals. The antenna array 14 may include a plurality of radiating elements that are arranged in an array according to a specific rule, and each radiating element can radiate and receive electromagnetic waves. The antenna element may include an antenna element. In the antenna array 14, operating frequency bands of different radiating elements may be the same or different. The antenna element may include a radiating structure and a feed structure that are connected. The radiating structure is configured to radiate and receive signals. The feed structure is connected to the radiating structure and the feed network, to transmit, to the radiating structure, an electrical signal transmitted by the feed network, and transmit, to the feed network, the signal received by the radiating structure.

The base station antenna may further include the reflection panel. The reflection panel may also be referred to as a bottom panel, an antenna panel, a reflection surface, or the like. For example, the reflection panel may be manufactured by using a metal material. A radiating element may be mounted on a surface on a side of the reflection panel. When the radiating element receives an antenna signal, the reflection panel may reflect and aggregate the antenna signal on a receiving point, to implement directional receiving. When the radiating element transmits an antenna signal, the reflection panel may implement directional transmission of the antenna signal. The reflection panel may enhance a capability of receiving or transmitting an antenna signal of the radiating element, and can further block and shield an interference effect of another signal from a back (where the back refers to a side that is of the reflection panel and that faces away from the radiating element) of the reflection panel on the antenna signal, to increase a gain of the antenna.

The radio frequency processing unit 15 (which may also be referred to as a remote radio unit (RRU)) may be connected to the feed network through a jumper, and is electrically connected to the antenna array 14 through the feed network. The feed network (which is further described below) may serve as a signal transmission path between the radio frequency processing unit 15 and the antenna array 14. The radio frequency processing unit 15 may be electrically connected to the baseband processing unit 17 (which may also be referred to as a baseband unit (BBU)) through the cable 16 (for example, an optical cable). As shown in FIG. 2, both the radio frequency processing unit 15 and the baseband processing unit 17 may be located outside the radome 13, and the radio frequency processing unit 15 may be located at a near end of the base station antenna.

The radio frequency processing unit 15 may perform frequency selection, amplification, and down-conversion on an antenna signal received by the antenna array 14, convert a processed antenna signal into an intermediate frequency signal or a baseband signal, and send the intermediate frequency signal or the baseband signal to the baseband processing unit 17. The radio frequency processing unit 15 may alternatively perform up-conversion and amplification a baseband signal or an intermediate frequency signal, and convert a processed baseband signal or intermediate frequency signal into an electromagnetic wave through the antenna array 14 and send the electromagnetic wave.

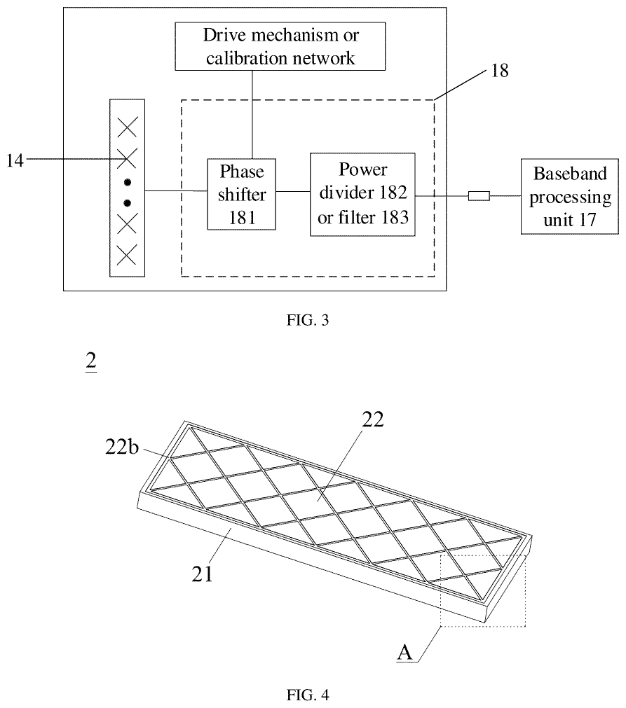

FIG. 3 may show an internal framework structure of a part of the base station 1 in FIG. 2. As shown in FIG. 3, the antenna array 14 of the base station 1 is connected to a feed network 18. The feed network 18 may implement different radiation beam directions through a drive mechanism, or may be connected to a calibration network to obtain a calibration signal required by the base station 1. The feed network 18 may feed a signal to the antenna array 14 based on a specific amplitude and phase, or send a received signal to the baseband processing unit 17 based on a specific amplitude and phase.

For example, the feed network 18 may include a phase shifter 181, and the phase shifter 181 is configured to change a maximum radiation direction of the antenna signal. The feed network 18 may further include a module configured to extend performance, for example, a power divider 182. The power divider 182 is configured to combine a plurality of signals into one signal and transmit the signal through the antenna array 14. Alternatively, the power divider 182 divides one signal into a plurality of signals. For example, the signal received by the antenna array 14 is divided into a plurality of signals based on different frequencies and transmitted to the baseband processing unit 17 for processing. The feed network 18 may further include a filter 183, configured to filter out an interference signal. The feed network 18 may further include a combiner. The feed network 18 may further include a transmission line in any form, such as a coaxial line, a strip line, or a microstrip.

The structure of the base station 1 shown in FIG. 2 and FIG. 3 is merely an example. Actually, a structure of the base station in embodiments of this application may be flexibly designed based on a product requirement, and is not limited to the foregoing descriptions. For example, the base station may alternatively not include the pole 11, and the radome 13 may be fastened to a tower through the pole support 12.

The following describes a structure of the antenna element in Embodiment 1.

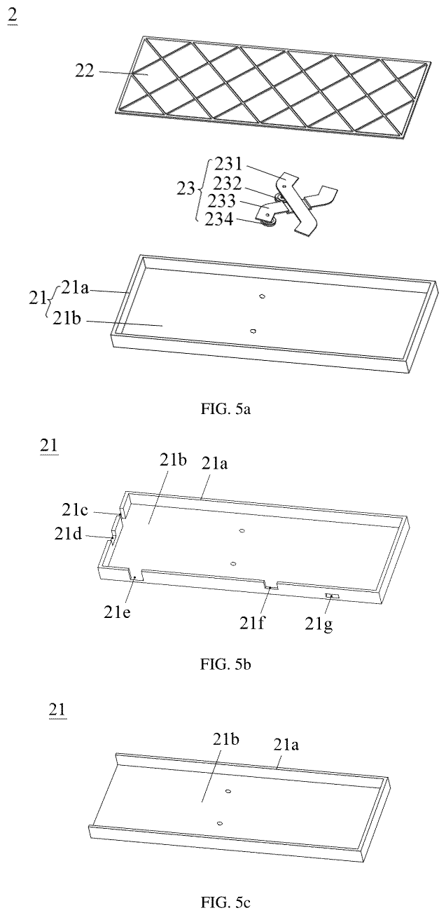

FIG. 4 is a diagram of an assembled structure of the antenna element 2 from an angle of view. FIG. 5a is a diagram of a disassembled structure of the antenna element 2 shown in FIG. 4. As shown in FIG. 4 and FIG. 5a, the antenna element 2 may include a conductive frame body 21, a radiative metasurface structure 22, and a feed structure 23. The conductive frame body 21 and the radiative metasurface structure 22 may be components of a radiating structure. The radiative metasurface structure 22 is assembled on the conductive frame body 21, and the feed structure 23 may be mounted in the conductive frame body 21.

As shown in FIG. 5a, the conductive frame body 21 may include a first conductive structure 21a and a conductive layer 21b. The first conductive structure 21a surrounds an edge of the conductive layer 21b once, that is, the first conductive structure 21a surrounds all areas of the edge of the conductive layer 21b. The first conductive structure 21a and the conductive layer 21b may be directly connected to form a frame body structure, the first conductive structure 21a may be used as a peripheral side wall, and the conductive layer 21b may be used as a bottom wall. For example, the conductive frame body 21 may be manufactured by using an integrated process (for example, a profile machining process), and such a conductive frame body 21 has an integrated structure. Alternatively, the conductive frame body 21 may be formed by assembling the first conductive structure 21a and the conductive layer 21b.

As shown in FIG. 5a, for example, the first conductive structure 21a may be a continuous and complete peripheral side wall. As shown in FIG. 5b, in another implementation, the first conductive structure 21a may alternatively have a plurality of notches, for example, a notch 21c, a notch 21d, a notch 21e, a notch 21f, and a notch 21g.

As shown in FIG. 5b, the notch 21c and the notch 21d may be provided on a short side of the first conductive structure 21a. The notch 21c and the notch 21d may pass through a top surface (a surface facing away from the conductive layer 21b) of the first conductive structure 21a, the notch 21c may be deep to extend to the conductive layer 21b, and the notch 21d may be shallow not to extend to the conductive layer 21b (a depth may be measured by using a size in a direction perpendicular to the conductive layer 21b). It may also be considered that the notch 21c and the notch 21d pass through the first conductive structure 21a in a thickness direction of the first conductive structure 21a (a wall thickness direction of the peripheral side wall).

As shown in FIG. 5b, the notch 21e to the notch 21g may be provided on a long side of the first conductive structure 21a. The notch 21e and the notch 21f may pass through the top surface of the first conductive structure 21a, the notch 21e may be deep to extend to the conductive layer 21b, and the notch 21f may be shallow not to extend to the conductive layer 21b. The notch 21g may not pass through the top surface of the first conductive structure 21a, the notch 21g may extend to the conductive layer 21b or does not extend to the conductive layer 21b, and the notch 21g may be a through hole. It may also be considered that the notch 21e to the notch 21g pass through the first conductive structure 21a in the thickness direction of the first conductive structure 21a.

The notches shown in FIG. 5b are merely an example. Actually, a quantity and structures (the structure includes structural parameters such as a shape and a size) of the notches are not limited in this implementation. There may be at least one notch in the first conductive structure 21a, and the notch may be provided at any position of the first conductive structure 21a. Structures of different notches in the first conductive structure 21a may be basically consistent or not completely consistent.

As shown in FIG. 5c, in another implementation, one short side may be removed from the first conductive structure 21a, and three sides remain. In this way, the first conductive structure 21a surrounds a part of the edge of the conductive layer 21b. The structure shown in FIG. 5c is merely an example. Actually, any quantity of sides at any position may be removed from the first conductive structure 21a. For example, any long side may be removed, or any short side and any long side may be removed. In an implementation, only one side may be retained for the first conductive structure 21a.

In another implementation, the first conductive structure 21a may be a combination shown in FIG. 5b and FIG. 5c, that is, at least one side may be removed from the first conductive structure 21a, and at least one notch is provided at any position of a remaining side.

In Embodiment 1, the first conductive structure 21a and the conductive layer 21b are directly connected and electrically conducted (or referred to as an electrical connection, where the electrical connection is a circuit connection in physical contact, and an electrical signal may be transmitted through a physical line). The conductive frame body 21 enclosed by the first conductive structure 21a and the conductive layer 21b is conductive, and such a conductive frame body 21 may also be referred to as a back cavity. Because the conductive frame body 21 is an independent physical structure, the back cavity formed by the conductive frame body 21 may also be referred to as a physical back cavity.

In another embodiment, the first conductive structure 21a and the conductive layer 21b are not directly connected in terms of a structure, and the first conductive structure 21a and the conductive layer 21b may be coupled. For example, a design may be performed based on FIG. 5a, so that an end that is of the first conductive structure 21a and that is close to the conductive layer 21b may form a bent side, and the first conductive structure 21a having the bent side may be approximately in a “⊥” shape or an “L” shape. There is a gap between the bent side and the conductive layer 21b. The bent side may be connected to the conductive layer 21b through an insulated connecting piece (for example, a rivet), and the first conductive structure 21a and the conductive layer 21b transmit a signal in a coupling manner.

For example, the following continues to provide descriptions by using an example in which the first conductive structure 21a is connected to the conductive layer 21b and the first conductive structure 21a surrounds the edge of the conductive layer 21b once and is provided with no notch.

For example, a height of the conductive frame body 21 may be 0.01*wavelength to 0.2*wavelength (including endpoint values), and the height may be a size in a direction perpendicular to the conductive layer 21b.

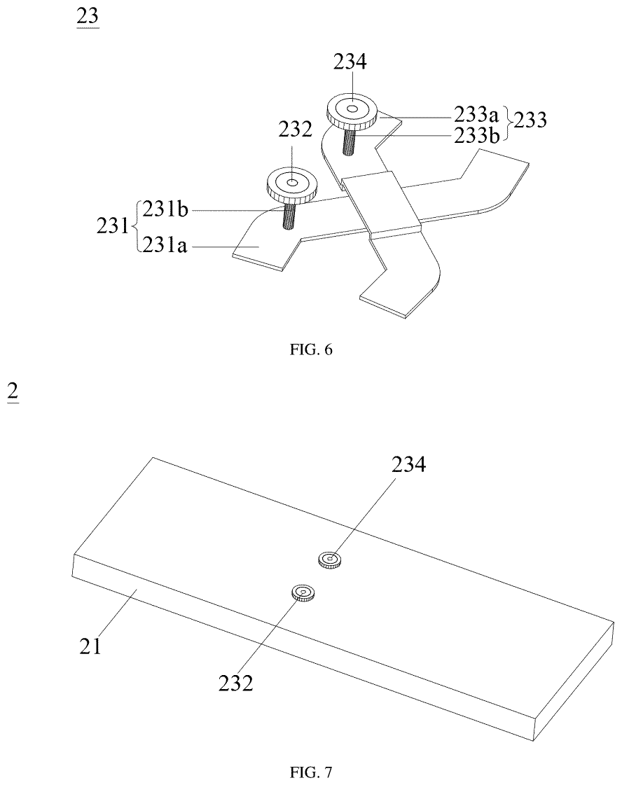

FIG. 5a and FIG. 6 may respectively represent example structures of the feed structure 23 from different angles of view. As shown in FIG. 5a and FIG. 6, the feed structure 23 may include a first probe 231, a first feed port 232, a second probe 233, and a second feed port 234.

As shown in FIG. 6, the first probe 231 may include a first part 231a and a second part 231b, the first part 231a may be approximately sheet-shaped, and the second part 231b may be approximately rod-shaped. The second part 231b may be erected on the first part 231a. The second part 231b may be connected between the first part 231a and the first feed port 232. A structure of the first feed port 232 is not limited. For example, the first feed port 232 may be a coaxial-line feed interface.

As shown in FIG. 6, the second probe 233 may include a first part 233a and a second part 233b, the first part 233a may be approximately sheet-shaped, and the second part 233b may be approximately rod-shaped. The second part 233b may be erected on the first part 233a. The second part 233b may be connected between the first part 233a and the second feed port 234. A structure of the second feed port 234 is not limited. For example, the second feed port 234 may be a coaxial-line feed interface.

As shown in FIG. 6, the first part 231a and the first part 233a may be arranged in a cross manner. The first feed port 232 and the second feed port 234 may be located on a same side of the first part 231a and the first part 233a.

FIG. 7 is a diagram of an assembled structure of the antenna element 2 from another angle of view, and may represent a position relationship between the feed structure 23 and the conductive frame body 21. With reference to FIG. 5a to FIG. 7, when the feed structure 23 is mounted in the conductive frame body 21, the first part 231a and the first part 233a may be stacked and spaced with the conductive layer 21b. At least a part of the first feed port 232 and the second feed port 234 may be exposed outside the conductive frame body 21.

In Embodiment 1, both the first feed port 232 and the second feed port 234 may be connected to an external connector (for example, an SMA connector), so that the feed structure 23 is electrically connected to the feed network. Both the first probe 231 and the second probe 233 that are located in the conductive frame body 21 may be coupled to the radiating structure, and excite the radiating structure.

The feed structure 23 in Embodiment 1 may be a probe feed structure. In another embodiment, another feed structure may be used to replace the probe feed structure, for example, a dipole feed structure or a patch feed structure.

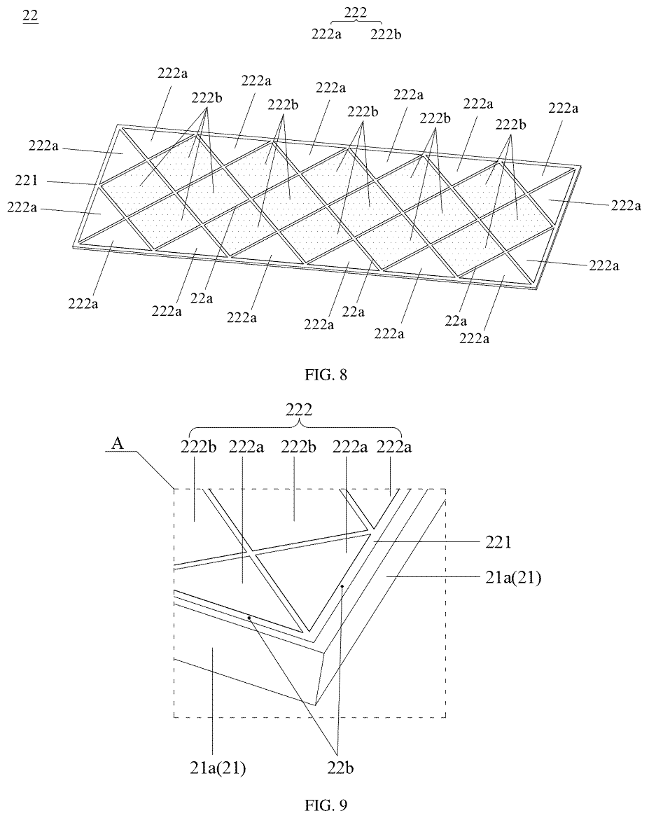

As shown in FIG. 8, the radiative metasurface structure 22 may include a first dielectric layer 221 and a radiative metasurface 222 formed on a surface of the first dielectric layer 221, and a boundary around the radiative metasurface 222 may be retracted within a corresponding boundary of the first dielectric layer 221. For example, the radiative metasurface structure 22 may be manufactured by using a printed circuit board (PCB) process, and the radiative metasurface structure 22 may be a PCB. Alternatively, the radiative metasurface structure 22 may be manufactured by using another appropriate process.

The first dielectric layer 221 is an insulated material layer, and may be, for example, a material layer in a PCB (when the radiative metasurface structure 22 is the PCB), or another appropriate material layer.

As shown in FIG. 8, the radiative metasurface 222 may include a plurality of conductive units, and a quantity of conductive units (which may also be referred to as patches) may be, for example, at least four. There is a gap 22a (which may be referred to as a second gap) between every two adjacent conductive units. These gaps 22a separate the conductive units, and all the gaps 22a may be in communication with each other.

An extension direction of the gap 22a may be designed based on a requirement. For example, in FIG. 8, the gap 22a may extend in directions of ±45°, a plurality of gaps 22a may be collinear and connected into a row, and may form a plurality of parallel rows. Rows with different extension directions may cross each other (for example, cross vertically). A shape of the gap 22a may be designed based on a requirement. For example, all the gaps 22a may be in a straight-line shape. A size of the gap 22a may be designed based on a requirement. For example, sizes of all the gaps 22a may be consistent. The size may include at least one of a shape size and a position size. The shape size may include at least one of a width, a length, a depth, and the like. The position size may include at least one of an included angle between adjacent cross slots, a spacing between parallel slots, and the like.

As shown in FIG. 8, corresponding to the structure and distribution of the gap 22a, the conductive units in the radiative metasurface 222 may be classified into edge conductive units 222a and internal conductive units 222b (for differentiation, the internal conductive unit 222b is shown in a shadow). There may be a plurality of edge conductive units 222a and a plurality of internal conductive units 222b, and the edge conductive units 222a enclose the internal conductive units 222b. The edge conductive unit 222a may have, for example, a triangular structure, and shapes and sizes of the edge conductive units 222a may be, for example, consistent. The internal conductive unit 222b may have, for example, a diamond-shaped structure, and shapes and sizes of the internal conductive units 222b may be, for example, consistent.

Different from that shown in FIG. 8, in another implementation, the gap 22a may extend in directions of 0° and 90°, that is, the radiative metasurface 222 may have a “grid-shaped” structure, and both the edge conductive unit 222a and the internal conductive unit 222b may be rectangular. In this implementation, a plurality of parallel gaps 22a may be arranged at an equal spacing or an unequal spacing, and shapes and sizes of the conductive units obtained through division may be consistent or not completely consistent.

In another embodiment, the gap 22a may alternatively be designed to be in another shape, including but not limited to an arc, an “H” shape, and the like. The edge conductive unit 222a and the internal conductive unit 222b that are obtained through division based on the gaps 22a may also have corresponding shapes.

The gaps 22a and the conductive units shown in FIG. 8 may be considered to have a uniform and regular design. In another embodiment, the gaps 22a may be non-uniform and irregular. In the non-uniform and irregular design, shapes of all the gaps 22a are not completely consistent, and/or sizes of all the gaps 22a are not completely consistent. Correspondingly, the edge conductive unit 222a and the internal conductive unit 222b that are obtained through division based on the non-uniform and irregular gaps 22a may also have corresponding shapes and sizes.

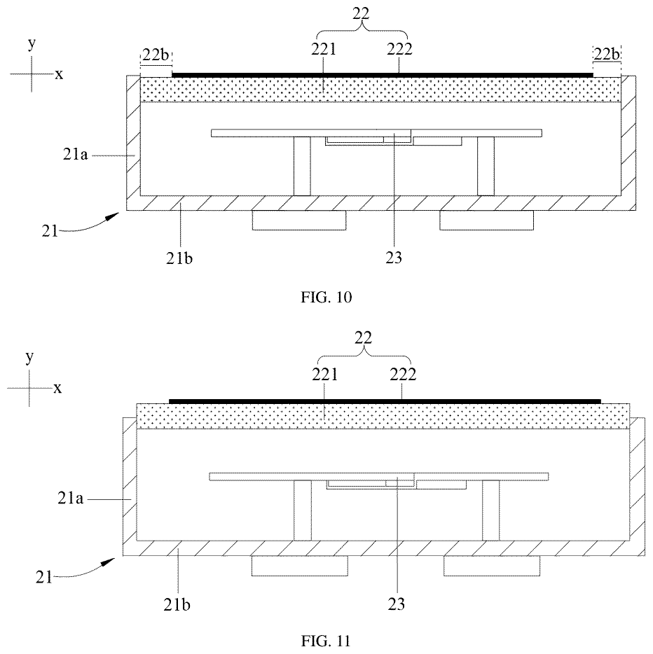

FIG. 9 and FIG. 10 may show a position relationship among the radiative metasurface structure 22, the feed structure 23, and the conductive frame body 21. FIG. 9 is a partial enlarged view of a position A in FIG. 4. FIG. 10 is a side sectional view of the structure shown in FIG. 4 (to highlight a key feature, the feed structure 23 is not shown in FIG. 10).

With reference to FIG. 8 to FIG. 10, the first dielectric layer 221 may be mounted in the conductive frame body 21, and the first dielectric layer 221 may be connected to an inner side surface of the first conductive structure 21a. The first dielectric layer 221 and the conductive layer 21b may be stacked, and space between the first dielectric layer 221 and the conductive layer 21b may be used to accommodate a probe of the feed structure 23. The radiative metasurface 222 may be located on a side that is of the first dielectric layer 221 and that faces away from the conductive layer 21b. As shown in FIG. 10 and FIG. 4, there may be a gap 22b (which may be referred to as a first gap) between the radiative metasurface 222 and the first conductive structure 21a, and the gap 22b may surround the radiative metasurface 222 once.

A size of the gap 22b may include an x-direction size and a y-direction size in FIG. 10 (an identification manner of the reference numeral 22b in FIG. 10 is merely an example). A size range of the gap 22b may be, for example, 0.001*wavelength to 0.05*wavelength (including endpoint values).

For example, shapes and sizes (for example, at least one of a width, a length, and a depth) of the gaps 22b may be consistent, and such gaps 22b may be considered uniform and regular. In another embodiment, shapes and/or sizes of the gaps 22b may not be completely consistent (for example, as shown in FIG. 4, widths of the gaps 22b may be different at a long side and a short side of the antenna element 2). Such gaps 22b may be considered non-uniform and irregular.

As shown in FIG. 10, the first dielectric layer 221 may be completely located in the conductive frame body 21, and the radiative metasurface 222 may be basically flush with a top surface (a surface that is of the first conductive structure 21a and that faces away from the conductive layer 21b) of the first conductive structure 21a. In another implementation, the radiative metasurface 222 may alternatively have a step difference with the top surface of the first conductive structure 21a.

For example, as shown in FIG. 11, a part of the first dielectric layer 221 may be located outside the conductive frame body 21, and the radiative metasurface 222 may be higher than the top surface of the first conductive structure 21a. In this solution, there is still a first gap between the radiative metasurface 222 and the first conductive structure 21a, and the first gap has an x-direction size and a y-direction size in FIG. 11.

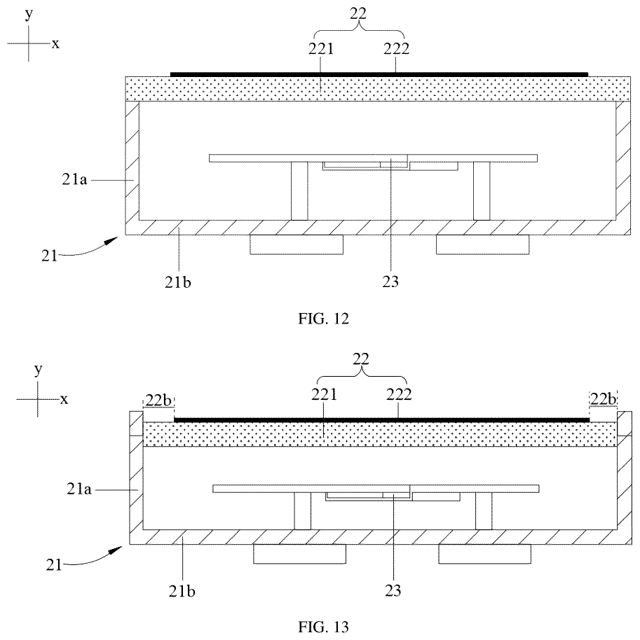

Alternatively, for example, as shown in FIG. 12, the first dielectric layer 221 may be completely located outside the conductive frame body 21, and the first dielectric layer 221 may be, for example, supported on the top surface of the first conductive structure 21a. Clearly, the radiative metasurface 222 is higher than the top surface of the first conductive structure 21a. In this solution, there is still a first gap between the radiative metasurface 222 and the first conductive structure 21a, and the first gap has an x-direction size and a y-direction size in FIG. 12.

The structure shown in FIG. 12 may be applied to an antenna array. In the antenna array, all antenna elements 2 may share a large-area first dielectric layer (or in other words, a plurality of small first dielectric layers 221 are connected to form a large first dielectric layer). The first dielectric layer is supported on top surfaces of first conductive structures 21a of all conductive frame bodies 21. A plurality of radiative metasurfaces 222 are disposed on the first dielectric layer, and one radiative metasurface 222 corresponds to one conductive frame body 21.

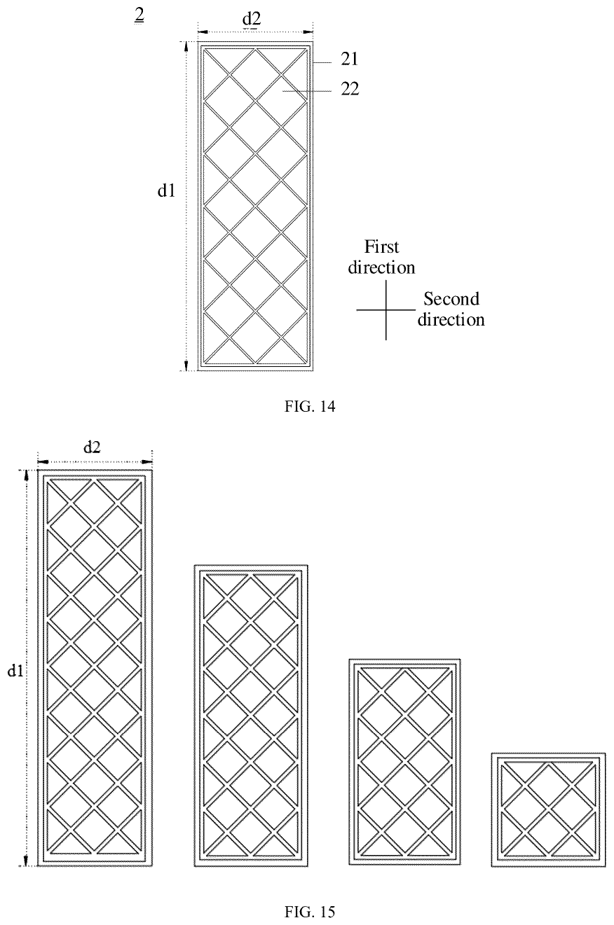

Alternatively, for example, as shown in FIG. 13, the first dielectric layer 221 may be completely located in the conductive frame body 21, and the radiative metasurface 222 may be lower than the top surface of the first conductive structure 21a. In this solution, there is still a first gap between the radiative metasurface 222 and the first conductive structure 21a, and the first gap has an x-direction size and a y-direction size in FIG. 13.

In the implementations shown in FIG. 10 to FIG. 13, the radiative metasurface 222 is located in space of the conductive frame body 21, that is, an orthographic projection of the radiative metasurface 222 on the conductive layer 21b completely falls into the space of the conductive frame body 21. Based on the foregoing design, in another implementation, a part of the first dielectric layer 221 may further extend to the outside of the conductive frame body 21 in the x direction, and a part of the radiative metasurface 222 may further extend to the outside of the conductive frame body 21 in the x direction. That is, a part of the orthographic projection of the radiative metasurface 222 on the conductive layer 21b may fall into the space of the conductive frame body 21, and the other part of the orthographic projection may be located outside the space of the conductive frame body 21. In the another implementation, there is still a first gap between the radiative metasurface 222 and the first conductive structure 21a.

In this embodiment of this application, any one of the foregoing implementations may be used based on a requirement to obtain an appropriate first gap. The first gap may be designed to adjust cross polarization of the antenna element 2, so that the antenna element 2 implements good antenna cross polarization discrimination (which is further described below).

As shown in FIG. 14, the antenna element 2 in Embodiment 1 may have a first size d1 in a first direction. The first direction may be, for example, a vertical direction in FIG. 14. When the antenna element 2 is mounted on a pole, the first direction may also be a vertical direction that is approximately perpendicular to the ground. The antenna element 2 may further have a second size d2 in a second direction. The second direction may be, for example, a horizontal direction in FIG. 14. When the antenna element 2 is mounted on a pole, the second direction may also be a horizontal direction that is approximately parallel to the ground. The first size d1 and the second size d2 of the antenna element 2 may be mainly determined based on a size of the radiative metasurface structure 22. The first size d1 may be approximately equal to a size of the radiative metasurface structure 22 in the first direction, and the second size d2 may be approximately equal to a size of the radiative metasurface structure 22 in the second direction. For example, the first size d1 may be between 0.4*wavelength and 2*wavelength (for example, 0.4*wavelength, 0.60*wavelength, or 2*wavelength), and the second size d2 may be between 0.3*wavelength and 0.9*wavelength (for example, 0.3*wavelength, 0.4*wavelength, or 0.9*wavelength).

In this embodiment, a ratio of the first size d1 to the second size d2 may be freely adjusted based on a requirement, the ratio≥1, and the ratio may be an integer or not an integer. For example, FIG. 15 shows a plurality of antenna elements with different ratios. As shown in FIG. 15, from left to right, the ratio may be in a decreasing trend, and a ratio for a rightmost antenna element may be, for example, 1. As shown in FIG. 15, based on a design requirement of the antenna, the second size d2 may be basically fixed. A beam width in the vertical direction may be adjusted by adjusting the first size d1. For example, the beam width in the vertical direction may be reduced by increasing the first size d1, to improve a gain and efficiency of the antenna.

In this embodiment, when the ratio of the first size d1 to the second size d2 is large, for example, when the ratio≥4, the antenna element is “narrow and long”, and it is difficult for an excitation area of a single feed structure to cover the entire radiating structure. To ensure an excitation effect of the feed structure, at least two feed structures may be disposed in the conductive frame body, and these feed structures are spaced.

In the implementation shown in FIG. 14, the first size d1 may be greater than the second size d2, and such an antenna element 2 is an asymmetric antenna. The asymmetric antenna may independently adjust and control beam widths in a horizontal direction and a vertical direction, which helps increase the antenna gain, simplify a feed network, reduce a feed loss, and improve overall antenna efficiency. In addition, for the asymmetric antenna element, a smaller second size d2 facilitates a compact antenna array design in the horizontal direction.

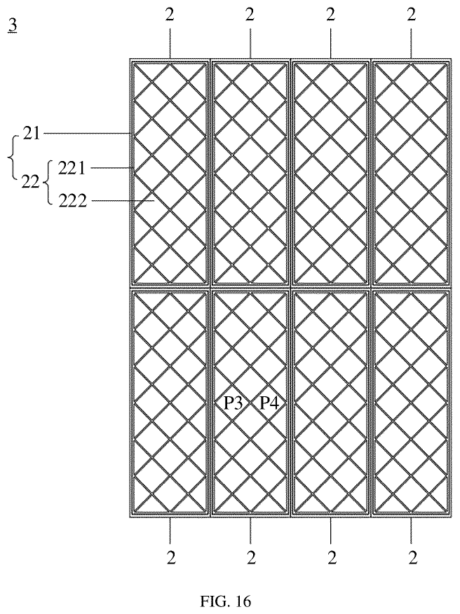

For example, FIG. 16 shows a top view of a structure of an antenna array 3 formed by a plurality of antenna elements 2. As shown in FIG. 16, the antenna elements 2 in the antenna array 3 may be closely arranged to form an array (for example, form a 4*2 array). Each antenna element 2 is independent, and the antenna elements 2 may not share a component.

In another implementation, the antenna elements 2 in the antenna array 3 may share a component. For example, radiative metasurfaces 222 of the antenna elements 2 may share a single large-area first dielectric layer, and the radiative metasurfaces 222 may be formed on the first dielectric layer (it may be considered that each first dielectric layer 221 in FIG. 8 is an area of the first dielectric layer). For example, the first dielectric layer may be supported in the manner shown in FIG. 12 on ends that are of first conductive structures 21a that face away from the conductive layer 21b. Alternatively, radiative metasurface structures 22 of the antenna elements 2 may share a single large conductive frame body, the conductive frame body has a plurality of cavities, and one radiative metasurface structure 22 and a corresponding feed structure 23 are correspondingly mounted in one cavity (it may be considered that each conductive frame body 21 in FIG. 5a is a partial structure of the single conductive frame body).

The following describes an operating principle and a characteristic of the antenna element 2.

For example, with reference to any one of FIG. 10 to FIG. 13, the feed structure 23 may receive, through a port, a feed signal transmitted by the feed network. Then, with reference to FIG. 5a and FIG. 8, the first probe 231 and the second probe 233 in the feed structure 23 may excite the conductive frame body 21 and the radiative metasurface structure 22, so that the gap 22b and each gap 22a radiate an electromagnetic wave. When two ports of the feed structure 23 are excited, the first probe 231 and the second probe 233 may each excite one polarization, so that the antenna element 2 can implement dual-polarized radiation (for example, ±45° dual-polarized). When only one port of the feed structure 23 is excited, one probe in the feed structure 23 may excite one polarization, so that the antenna element 2 can implement single-polarized radiation (for example, +45° polarization or −45° polarization).

The structure of the conductive unit in the radiative metasurface 222 and the second gap between the conductive units affect a propagation characteristic of the radiative metasurface 222. The structure of the conductive unit and the second gap between the conductive units may be designed to adjust an operating frequency and a bandwidth of the antenna, so that the antenna element 2 may operate in multi-mode or dual-mode, to extend the bandwidth of the antenna. As a back cavity, the conductive frame body 21 may provide a short-circuit boundary condition for the radiative metasurface 222, to restrict an operating mode of the antenna element 2. The notch provided on the first conductive structure 21a of the conductive frame body 21 may avoid other components (for example, a connecting piece such as a screw) in the antenna element 2, to facilitate mounting of these components. In addition, the radiative metasurface structure 22 may be thin, so that a thickness of the antenna element 2 may be small, to facilitate implementation of a low-profile antenna. In conclusion, the antenna element 2 may have a low-profile broadband characteristic.

The first gap between the radiative metasurface 222 and the first conductive structure 21a may be designed to adjust and control cross polarization discrimination of the asymmetric antenna element 2, so that the antenna element 2 has good cross polarization discrimination, and radiation performance is improved. It should be noted that the solutions in embodiments of this application can also improve cross polarization discrimination for the symmetric antenna element (the first size d1 is equal to the second size d2). Therefore, the solutions in embodiments of this application may be applied to the asymmetric antenna and the symmetric antenna.

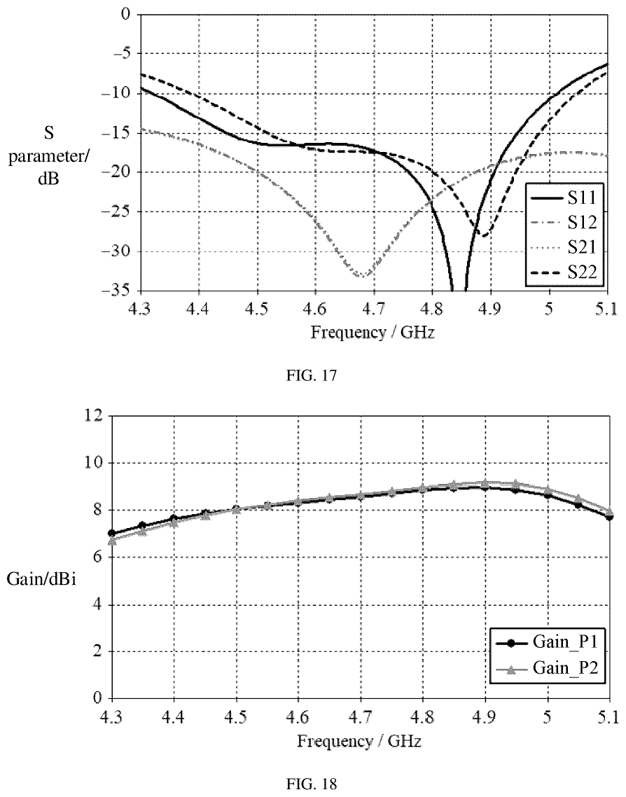

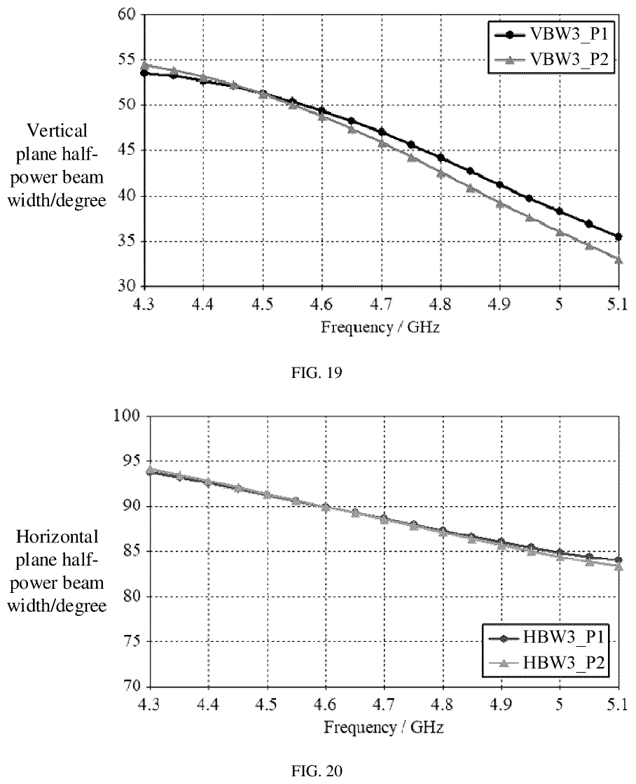

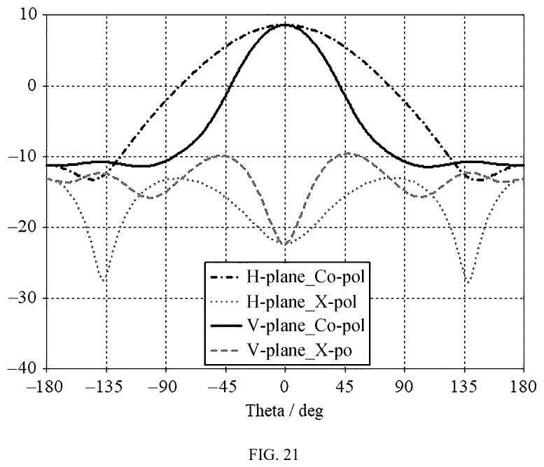

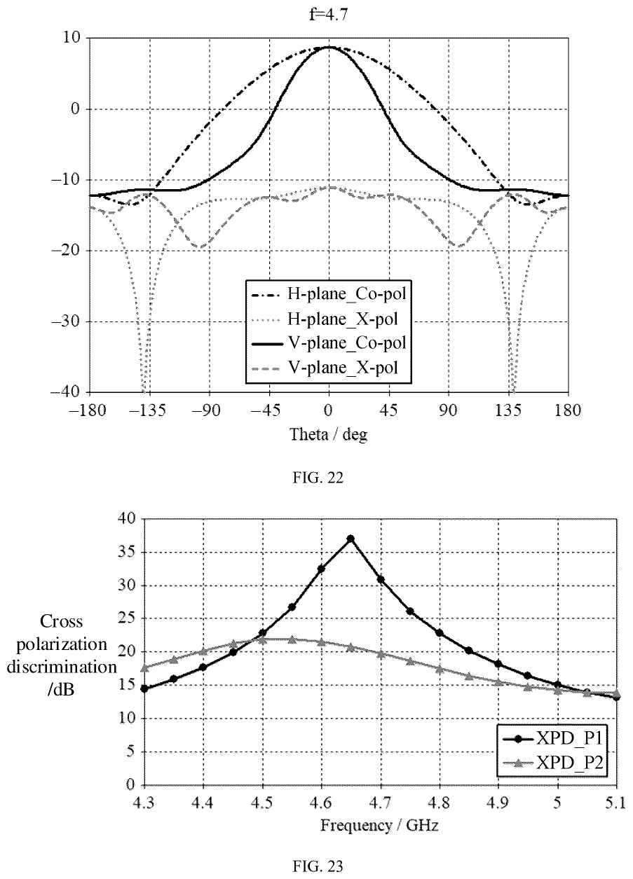

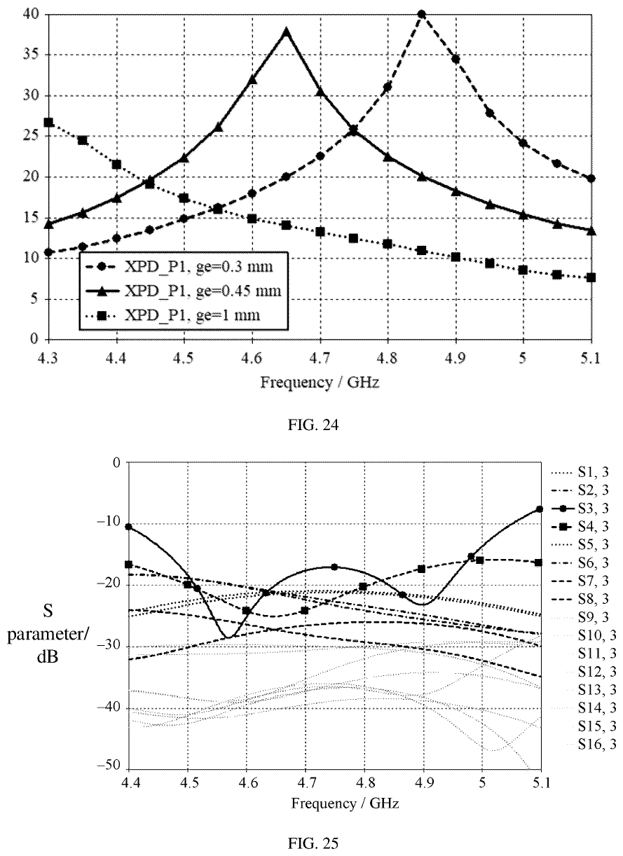

Performance of the antenna in embodiments of this application may be verified through simulation. FIG. 17 to FIG. 24 separately represent simulation result data. FIG. 17 may represent an S parameter of the antenna element. FIG. 18 may represent a gain of the antenna element. FIG. 19 may represent a vertical plane half-power beam width of the antenna element. FIG. 20 may represent a horizontal plane half-power beam width of the antenna element. FIG. 21 may represent a radiation pattern of a frequency 4.7 GHz excited by a first port of the antenna element. FIG. 22 may represent a radiation pattern of a frequency 4.7 GHz excited by a second port of the antenna element. FIG. 23 may represent cross polarization discrimination of the antenna element. FIG. 24 may represent impact of a first gap of the antenna element on cross polarization discrimination.

It can be learned with reference to FIG. 17 to FIG. 24 that in an operating bandwidth of 4.4 GHz to 5.0 GHz, the gain of the antenna is 7.5 dBi to 9.1 dBi, the half-power beam width in the horizontal direction is 88°, the half-power beam width in the vertical direction is 46°, the radiation pattern at a center frequency of frequency 4.7 GHz in dual polarization indicates that the antenna element has a capability of adjusting a beam width, cross-polarization discrimination of the antenna is greater than 15 dB, polarization isolation of the antenna is greater than 17 dB, and a design of the first gap can effectively adjust cross polarization discrimination of the antenna in the operating frequency band.

In this embodiment, the radiative metasurface 222 has an electromagnetic band gap (electromagnetic band gap, EBG) characteristic for a surface wave, and can suppress surface wave propagation in the operating frequency band of the antenna, to suppress antenna mutual coupling caused by surface wave propagation, implement an antenna self-decoupling function, improve isolation between antenna elements in a compact antenna array (for example, as shown in FIG. 16), reduce distortion of the radiation pattern, and improve wireless network performance.

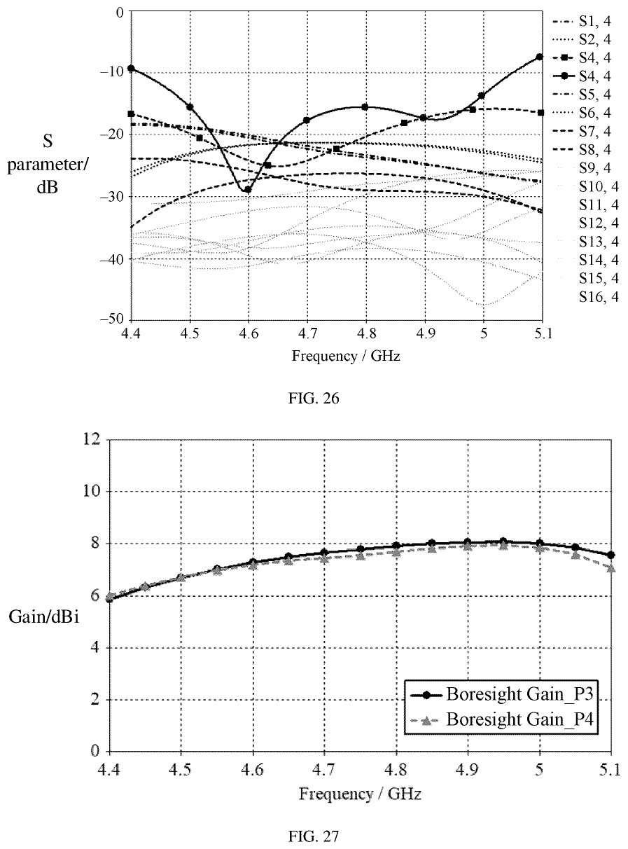

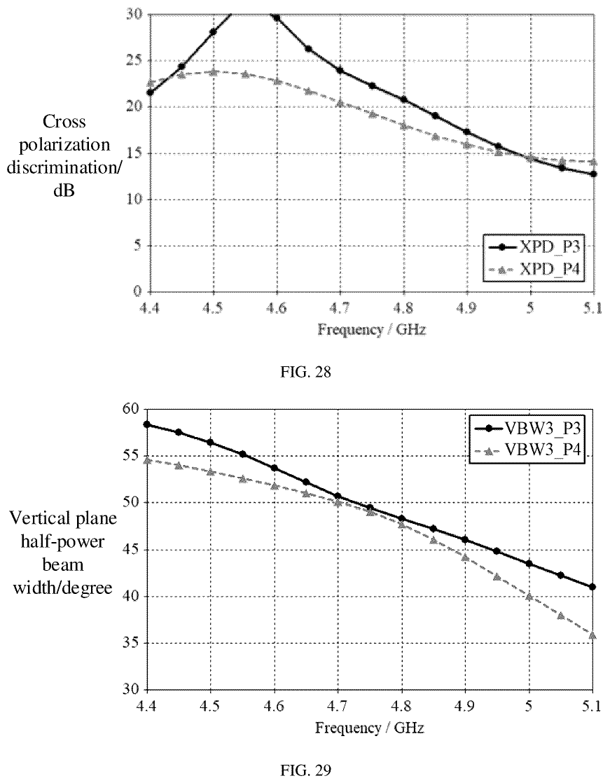

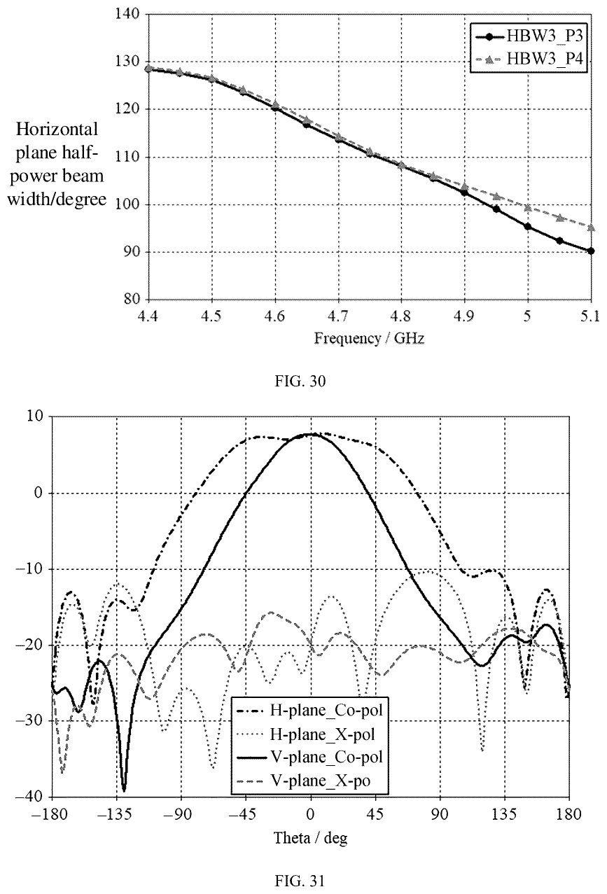

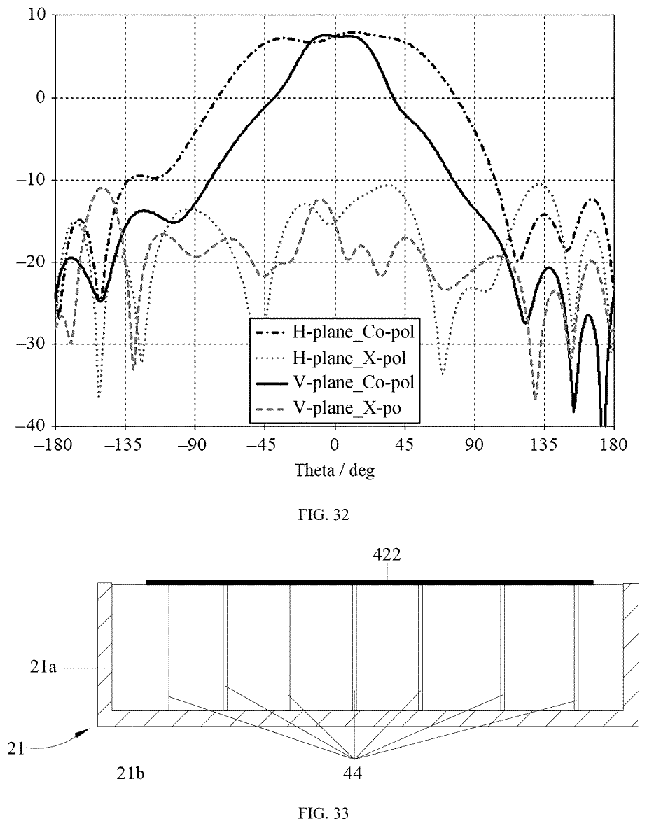

The foregoing antenna self-decoupling performance may be verified through simulation. For the antenna array 3 shown in FIG. 16, a horizontal center spacing between the antenna elements 2 may be 30 mm, and a vertical center spacing between the antenna elements 2 may be 80 mm. In addition, no additional decoupling structure is added. A decoupling effect of one antenna element 2 is investigated by exciting a port P3 and a port P4 of the antenna element 2, and simulation results shown in FIG. 25 to FIG. 32 are obtained. 25 to FIG. 32 may reflect performance of the antenna element 2 in an environment of the antenna array 3. FIG. 25 represents an S parameter excited by the port P3. FIG. 26 represents an S parameter excited by the port P4. FIG. 27 represents a gain of the antenna element 2. FIG. 28 represents cross polarization discrimination of the antenna element 2. FIG. 29 represents a vertical plane half-power beam width of the antenna element 2. FIG. 30 represents a horizontal plane half-power beam width of the antenna element 2. FIG. 31 represents a radiation pattern of a frequency 4.7 GHz excited by the port P3 of the antenna element 2. FIG. 32 represents a radiation pattern of a frequency 4.7 GHz excited by the port P4 of the antenna element 2.

It can be learned from the simulation results shown in FIG. 25 to FIG. 32 that in an operating frequency band of 4.4 GHz to 5.0 GHz, isolation between the antenna elements 2 is greater than 18 dB, and cross polarization discrimination is greater than 15 dB, which indicates that radiation performance of the antenna is good.

In some implementations of Embodiment 1, as shown in FIG. 10 to FIG. 13, the radiative metasurface 222 may be located on a side that is of the first dielectric layer 221 and that faces away from the conductive layer 21b. In some other implementations of this embodiment, the radiative metasurface 222 may alternatively be located on a side that is of the first dielectric layer 221 and that faces the conductive layer 21b. Alternatively, the radiative metasurface 222 is distributed on both a side that is of the first dielectric layer 221 and that faces away from the conductive layer 21b and a side that is of the first dielectric layer 221 and that faces the conductive layer 21b (that is, the radiative metasurface 222 is disposed on surfaces of two opposite sides of the first dielectric layer 221). Alternatively, the radiative metasurface 222 may be embedded in the first dielectric layer 221, that is, the radiative metasurface 222 may serve as an interlayer of the first dielectric layer 221. The foregoing designs can all implement excitation on the radiative metasurface 222. These designs can increase a degree of freedom of antenna design and meet a corresponding antenna design requirement.

In some implementations of Embodiment 1, the conductive unit in the radiative metasurface 222 may be electrically connected to the conductive layer 21b.

For example, with reference to any one of FIG. 10 to FIG. 13, a first conductive via may be designed in the first dielectric layer 221, and the first conductive via is electrically connected to the radiative metasurface 222. A first conductive column is connected between the conductive layer 21b and the first dielectric layer 221, and the first conductive column is electrically connected to the first conductive via. Therefore, the conductive unit can be electrically connected to the conductive layer 21b through the first conductive via and the first conductive column. At least one any conductive unit may be electrically connected to the conductive layer 21b, and such a conductive unit may be referred to as a first conductive unit. This design can increase a gain of the antenna element 2, and ensure isolation between antenna elements 2. Refer to FIG. 8. For example, the first conductive unit may be an internal conductive unit 222b, that is, the internal conductive unit 222b is electrically connected to the conductive layer 21b. This helps ensure an overall boundary condition of the radiating structure. Alternatively, the first conductive unit may be an edge conductive unit 222a, that is, the edge conductive unit 222a is electrically connected to the conductive layer 21b.

It may be understood that, for a solution in which the radiative metasurface 222 is embedded into the first dielectric layer 221, the first conductive via and the first conductive column may also be designed to electrically connect the first conductive unit to the conductive layer 21b.

Alternatively, for a solution in which the radiative metasurface 222 is disposed on a side that is of the first dielectric layer 221 and that faces the conductive layer 21b, the first conductive column may be connected between the conductive layer 21b and the radiative metasurface 222, and the first conductive unit can be electrically connected to the conductive layer 21b through the first conductive column.

Alternatively, for a solution in which the radiative metasurfaces 222 are distributed on both opposite sides of the first dielectric layer 221, the first conductive via may be designed in the first dielectric layer 221, and the first conductive via is electrically connected between first conductive units on the opposite sides of the first dielectric layer 221. In addition, the first conductive column may be connected between the conductive layer 21b and the first conductive unit (with reference to FIG. 10, that is, the first conductive unit located on a lower side of the first dielectric layer 221) located between the first dielectric layer 221 and the conductive layer 21b, and the first conductive column is electrically connected to the first conductive unit. Therefore, the first conductive units on two opposite sides of the first dielectric layer 221 can be electrically connected to the conductive layer 21b through the first conductive via and the first conductive column.

Different from the foregoing embodiment, in Embodiment 2 shown in FIG. 33, no insulated material layer may be disposed below the radiative metasurface 422, but the conductive layer 21b is supported by using a plurality of first support columns 44, one end of each first support column 44 is connected to the radiative metasurface 422, and the other end is connected to the conductive layer 21b. Each conductive unit of the radiative metasurface 422 is connected to at least one first support column 44 (to fully support a conductive unit, more than one first support column 44 may be used to support the conductive unit), that is, a quantity of first support columns 44 may be greater than or equal to a quantity of conductive units (the quantity of first support columns 44 in FIG. 33 is merely an example). A structure of the first support column 44 is not limited. It may be understood that, to highlight a key feature, the feed structure is not shown in FIG. 33.

In an implementation of Embodiment 2, to electrically connect a conductive unit to the conductive layer 21b, a first support column connected to the conductive unit may have conductive performance. The conductive unit is electrically connected to the conductive layer 21b, so that an antenna gain can be increased and isolation can be increased. It may be understood that a design of electrically connecting the conductive unit to the conductive layer 21b is not necessary.

Refer to FIG. 33. There is air in space between the radiative metasurface 422 and the conductive layer 21b, and it may be considered that the air is the first dielectric layer.

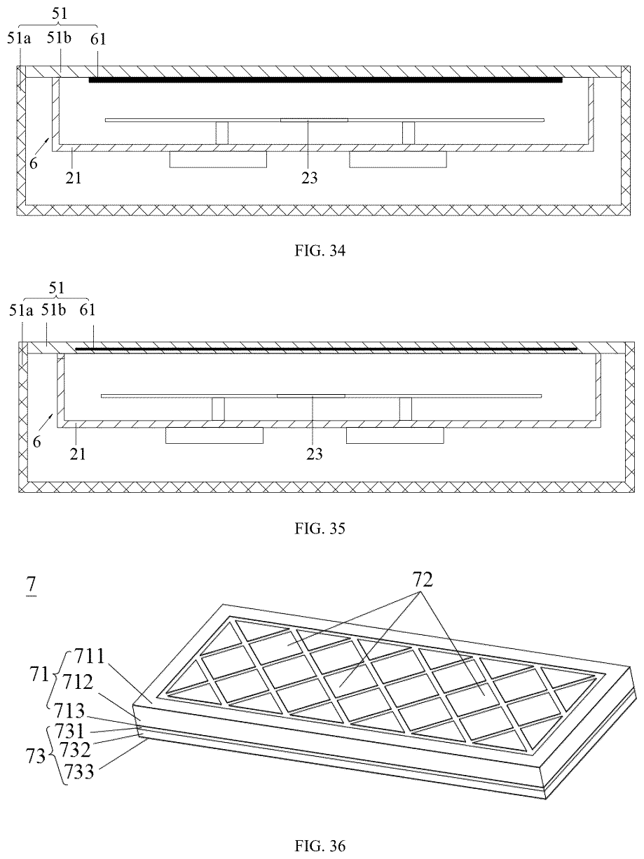

In the foregoing embodiment, the radiative metasurface of the antenna element mounted in the radome is independent of the radome. In Embodiment 3 shown in FIG. 34 and FIG. 35, the radiative metasurface may be integrated on the radome. The following provides descriptions.

As shown in FIG. 34, in an implementation of Embodiment 3, an antenna element 6 is mounted in a radome 51. The radome 51 may include a first cover 51a and a second cover 51b (which may be referred to as a front cover). There may be no need to additionally design the first dielectric layer for the antenna element 6, a side that is of a radiative metasurface 61 and that faces away from the feed structure 23 may be connected to the second cover 51b, and the radiative metasurface 61 and the second cover 51b may be integrated. For example, the radiative metasurface 61 may be formed in a process of manufacturing the radome 51. As shown in FIG. 34, the conductive frame body 21 may be connected to the second cover 51b. Alternatively, the conductive frame body 21 may have a specific spacing with the second cover 51b, and the conductive frame body 21 may be fastened in the radome 51 in another appropriate manner. For example, the conductive frame body 21 may be fastened to a reflection panel below the conductive frame body 21 by using a support structure.

It may be understood that the structure of the radome and the connection position of the radiative metasurface in the radome shown in FIG. 34 are merely examples, and are not intended to limit this embodiment. Based on a product requirement, the radome may further have another appropriate structure, and the radiative metasurface may be integrated in any appropriate position of the radome.

In the solution shown in FIG. 34, the second cover body 51b is equivalent to the foregoing first dielectric layer. In this solution, the radiative metasurface 222 and the second cover 51b are integrated, so that the radiative metasurface 222 can be effectively arranged by using structural space of the radome 51, to improve structural utilization and simplify an antenna structure. In addition, because the first dielectric layer does not need to be additionally designed, a thickness of the antenna can be reduced, and a low-profile antenna can be implemented.

As shown in FIG. 35, in another implementation of Embodiment 3, a difference from the solution shown in FIG. 34 is that the radiative metasurface 61 may be embedded between an inner surface and an outer surface of the second cover 51b, that is, the radiative metasurface 61 may serve as an interlayer of the second cover 51b. It may be considered that the second cover body 51b is located on a partial inner wall between the radiative metasurface 61 and the conductive frame body 21, and is the first dielectric layer bearing the radiative metasurface 61. The solution shown in FIG. 35 can optimize structural utilization, simplify an antenna structure, reduce a thickness of the antenna, and implement a low-profile antenna.

The back cavity of the antenna element in the foregoing embodiments is a physical back cavity. Different from the foregoing embodiments, the back cavity of the antenna element in the following embodiments may be referred to as an equivalent back cavity, which is described below.

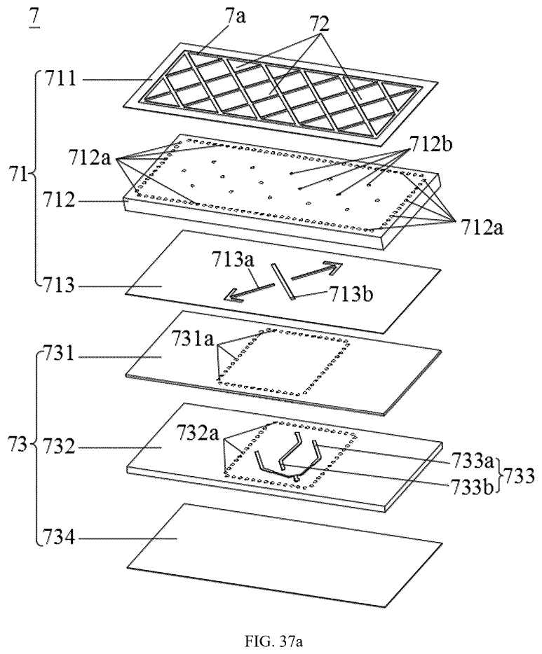

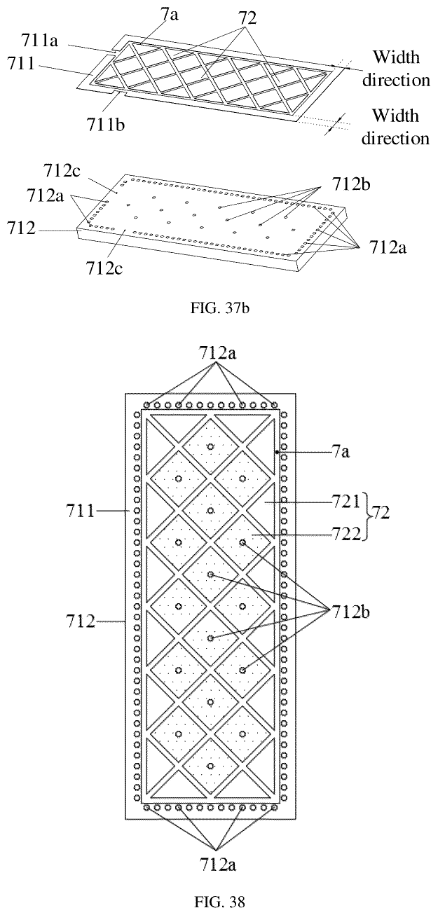

FIG. 36 shows an overall structure of an antenna element 7 according to Embodiment 4. FIG. 37a shows a disassembled structure of the antenna element 7 in FIG. 36. As shown in FIG. 36 and FIG. 37a, the antenna element 7 may include a radiating structure, and the radiating structure may include a back cavity 71 and a radiative metasurface 72. The antenna element 7 may further include a feed structure 73.

As shown in FIG. 37a, the back cavity 71 may include a conductive frame 711, a first dielectric layer 712, and a conductive layer 713 that are sequentially stacked, and the conductive frame 711 and the conductive layer 713 may be respectively connected to two opposite surfaces of the first dielectric layer 712.

As shown in FIG. 37a, the conductive frame 711 may have an annular structure surrounding once, and the conductive frame 711 may have a continuous and complete structure.

In another implementation, as shown in FIG. 37b, at least one notch may also be provided at any position of the conductive frame 711. For example, the notch may pass through the conductive frame 711 in a thickness direction of the conductive frame 711 (that is, a thickness direction of the radiative metasurface 72), and may pass through or not pass through the conductive frame 711 in a width direction (as shown in FIG. 37b) of the conductive frame 711. For example, a notch 711a may pass through the conductive frame 711 in the thickness direction of the conductive frame 711, and pass through the conductive frame 711 in the width direction of the conductive frame 711. A notch 711b may pass through the conductive frame 711 in the thickness direction of the conductive frame 711, but does not pass through the conductive frame 711 in the width direction of the conductive frame 711. In a case of passing through the conductive frame 711 in the width direction of the conductive frame 711, it may be considered that the conductive frame 711 includes a plurality of sub-frames that are sequentially spaced.

It may be understood that FIG. 37b is merely an example, and actually, a quantity and structures (the structure includes structural parameters such as a shape and a size) of notches of the conductive frame 711 are not limited. There may be at least one notch in the conductive frame 711, and the notch may be provided at any position of the conductive frame 711. Structures of different notches in the conductive frame 711 may be basically consistent or not completely consistent.

The conductive frame 711 may be conductive, for example, may be made of a metal material.

The first dielectric layer 712 is an insulated material layer. In an implementation, the first dielectric layer 712 may be, for example, a material layer in a PCB, or another appropriate material layer.

As shown in FIG. 37a, for example, a plurality of second conductive vias 712a may be formed in the first dielectric layer 712. A via wall of the second conductive via 712a may be conductive, and the second conductive via 712a may transmit a signal. These second conductive vias 712a may be approximately distributed at an equal spacing and surround once, and the second conductive vias 712a may be close to a periphery of the first dielectric layer 712. The second conductive via 712a may correspond to the conductive frame 711 and the conductive layer 713, and each second conductive via 712a may electrically connect the conductive frame 711 and the conductive layer 713.

In another implementation, as shown in FIG. 37b, the second conductive vias 712a may not be provided at some positions of the first dielectric layer 712, so that the second conductive vias 712a at these positions are sparse. For an “annular pattern” formed by all second conductive vias 712a, positions at which the second conductive vias 712a are not provided are equivalent to notches 712c formed on the “annular pattern”. The notch 712c of the “annular pattern” may be approximately aligned with the notch of the conductive frame 711, or the notch 712c and the notch may be distributed in a staggered manner.

It may be understood that FIG. 37b is merely an example. Actually, a quantity and positions of notches 712c are not limited. There may be at least one notch 712c, and the notch 712c may be formed at any position of the “annular pattern”. In addition, the notch of the conductive frame 711 and the notch 712c of the “annular pattern” do not need to exist at the same time, and the notch may be provided only on the conductive frame 711, or the notch 712c may be formed only on the “annular pattern”. Unless otherwise specified, the following continues to provide descriptions by using an example in which no notch is provided on the conductive frame 711 and the “annular pattern”.

As shown in FIG. 37a, for example, a plurality of third conductive vias 712b may be formed in the first dielectric layer 712. A via wall of the third conductive via 712b may be conductive, and the third conductive via 712b may transmit a signal. All the third conductive vias 712b are located inside the pattern enclosed by the plurality of second conductive vias 712a. The third conductive via 712b is used to electrically connect a first conductive unit in the radiative metasurface 72 to the conductive layer 713 (which is further described below). In another embodiment, the third conductive via 712b may alternatively not be provided.

The conductive layer 713 may be conductive, for example, may be made of a metal material. As shown in FIG. 37a, the conductive frame 711 and the conductive layer 713 are respectively disposed on two opposite surfaces of the first dielectric layer 712, and the second conductive via 712a is located between the conductive frame 711 and the conductive layer 713 and electrically connects the conductive frame 711 and the conductive layer 713. It may be considered that the plurality of second conductive vias 712a may be equivalent to the foregoing first conductive structure, the plurality of second conductive vias 712a and the conductive frame 711 may be equivalent to a peripheral side wall of the back cavity 71, and the conductive layer 713 may be equivalent to a bottom wall of the back cavity 71. The peripheral side wall of the back cavity 71 in this embodiment is not completely made of a physical material, and a connection manner between the peripheral side wall and the bottom wall is also different from that of a physical back cavity. However, electrical performance of the back cavity 71 is similar to that of the physical back cavity. Therefore, the back cavity 71 may be referred to as an equivalent back cavity.

In this embodiment, the first dielectric layer 712 in the back cavity 71 may be configured to bear the radiative metasurface 72 (which is further described below). The conductive layer 713 in the back cavity 71 may serve as a ground plane of the radiating structure, or may be reused as a ground plane of the feed structure 73 (which is further described below). This reuse design can improve structural utilization, make the structure of the antenna element 7 compact, simplify an antenna structure, further help reduce a thickness of the antenna, and implement a low-profile antenna.

FIG. 38 shows a relationship among the conductive frame 711, the radiative metasurface 72, and the first dielectric layer 712 by using a top view.

As shown in FIG. 37a and FIG. 38, the radiative metasurface 72 may be located in an inner periphery of the conductive frame 711, or in other words, the conductive frame 711 surrounds an edge of the radiative metasurface 72 once, that is, the conductive frame 711 surrounds all areas of the edge of the radiative metasurface 72. When the conductive frame 711 has the structure shown in FIG. 37b, the conductive frame 711 surrounds a part of the edge of the radiative metasurface 72.

As shown in FIG. 38, there is a gap 7a between the radiative metasurface 72 and the conductive frame 711. For example, shapes and sizes (for example, at least one of a width, a length, and a depth) of the gaps 7a may be consistent, and such gaps 7a may be considered uniform and regular. In another embodiment, shapes and/or sizes of the gaps 7a may not be completely consistent. Such gaps 7a may be considered non-uniform and irregular. The second conductive via 712a corresponds to and is electrically connected to the conductive frame 711. There is also a gap (which may be referred to as a first gap) between the radiative metasurface 72 and the second conductive via 712a. The first gap between the radiative metasurface 72 and the second conductive via 712a may be uniform and regular, or non-uniform and irregular.

With reference to FIG. 38 and FIG. 37a, the radiative metasurface 72 may be formed on a side of the first dielectric layer 712, and may be located on the same side of the first dielectric layer 712 as the conductive frame 711.

As shown in FIG. 38, the radiative metasurface 72 may also include an edge conductive unit 721 and an internal conductive unit 722 (for differentiation, the internal conductive unit 722 is shown in a shadow). All internal conductive units 722 may be electrically connected to the third conductive via 712b, and one internal conductive unit 722 may be electrically connected to at least one third conductive via 712b. With reference to FIG. 22 and FIG. 21, the internal conductive unit 722 may be electrically connected to the conductive layer 713 through the third conductive via 712b.

In another implementation, only a part of the internal conductive units 722 may be electrically connected to the third conductive via 712b; or only at least a part of the edge conductive units 721 may be electrically connected to the third conductive via 712b; or at least a part of the internal conductive units 722 and at least a part of the edge conductive units 721 may be electrically connected to the third conductive vias 712b. In the foregoing solution, the conductive unit may be electrically connected to the conductive layer 713 through the third conductive via 712b, and the conductive unit may be referred to as a first conductive unit. Alternatively, in another implementation, the third conductive via 712b may not be provided, and the conductive unit is not electrically connected to the conductive layer 713.

As shown in FIG. 36 and FIG. 37a, the feed structure 73 and the back cavity 71 are stacked, and may be located on a side that is of the back cavity 71 and that faces away from the radiative metasurface 72.

As shown in FIG. 37a, the feed structure 73 may include a third dielectric layer 731, a second dielectric layer 732, a feed line 733, and a ground plane 734 that are sequentially stacked. As described above, the conductive layer 713 may alternatively be reused as the ground plane of the feed structure 73. The feed structure 73 in this embodiment may be, for example, a strip line feed structure. The following provides descriptions in sequence.

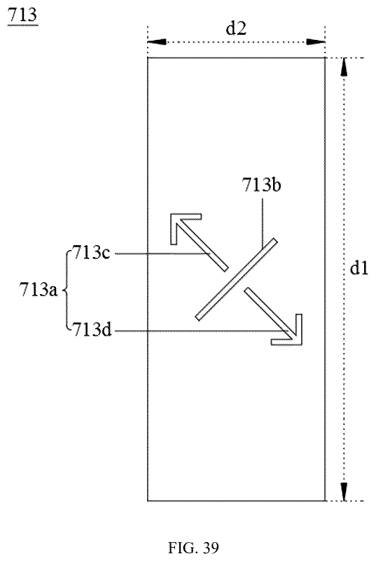

FIG. 39 is a top view of a structure of the conductive layer 713. As shown in FIG. 39 and FIG. 37a, a first coupling slot 713a and a second coupling slot 713b may be provided on the conductive layer 713, and main extension lines of the first coupling slot 713a and the second coupling slot 713b may be orthogonal. For example, from an angle of view of FIG. 39, the main extension line of the first coupling slot 713a may be in a −45° direction, and the main extension line of the second coupling slot 713b may be in a +45° direction. The second coupling slot 713b may be a continuous slot that is not interrupted. The first coupling slot 713a may include a part 713c and a part 713d. The two parts may be respectively located on two sides of the second coupling slot 713b, and the two parts may not be in communication with the second coupling slot 713b. Two ends that are of the two parts and that are away from each other may have arrow structures (the arrow structure is also a slot). The two arrow structures may be disposed opposite to each other (that is, arrow directions are opposite), and the two arrow structures may respectively point to two long sides of the conductive layer 713. The arrow structure may increase an electrical length of the first coupling slot 713a in limited space of the conductive layer 713, to facilitate impedance matching. The foregoing structure of the coupling slot is merely an example, and any other appropriate structure may be used based on a product requirement.

In this embodiment, the first coupling slot 713a may be used to excite +45° polarized radiation, and the second coupling slot 713b may be used to excite −45° polarized radiation. A design in which the first coupling slot 713a is broken into two parts may be used, so that the two polarized coupling slots do not affect each other.

The third dielectric layer 731 is an insulated material layer, and may be, for example, a material layer in a PCB, or another appropriate material layer. As shown in FIG. 37a, for example, a plurality of conductive vias 731a may be provided in the third dielectric layer 731, a via wall of the conductive via 731a may be conductive, and the conductive via 731a may transmit a signal. The conductive vias 731a may be arranged in a ring shape. A ring formed by the conductive vias 731a may correspond to the first coupling slot 713a, the second coupling slot 713b, and the feed line 733, which is further described below.

As shown in FIG. 37a, the feed line 733 may be located between the third dielectric layer 731 and the second dielectric layer 732. For example, the feed line 733 may be made on a surface of the second dielectric layer 732. The feed line 733 may include a first feed line 733a and a second feed line 733b.

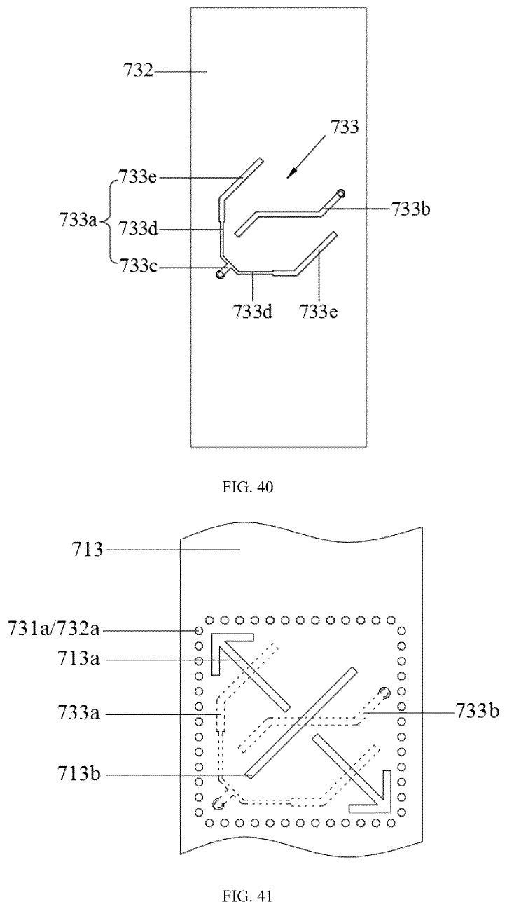

As shown in FIG. 40, for example, the first feed line 733a may include a 50-ohm strip line 733c, a quarter impedance converter 733d, and a bent strip line 733e, and the 50-ohm strip line 733c, the quarter impedance converter 733d, and the bent strip line 733e may be connected in sequence. The first feed line 733a may have a symmetric structure. Each of two opposite sides of the 50-ohm strip line 733c may have one quarter impedance converter 733d, and each of the two opposite sides of the 50-ohm strip line 733c may have one bent strip line 733e. An end part of the 50-ohm strip line 733c may be connected to an external connector (for example, an SMA connector) through a transfer transition structure (or referred to as a port), so that the first feed line 733a is electrically connected to the feed network. The first feed line 733a may excite the first coupling slot 713a.

As shown in FIG. 40, for example, the second feed line 733b may have a symmetric structure, and may be a 50-ohm strip line. An end part of the second feed line 733b may be connected to an external connector (for example, an SMA connector) through a transfer transition structure, so that the second feed line 733b is electrically connected to the feed network. The second feed line 733b may excite the second coupling slot 713b.

The second dielectric layer 732 is an insulated material layer, and may be, for example, a material layer in a PCB, or another appropriate material layer. As shown in FIG. 37a, for example, a plurality of conductive vias 732a may be provided in the second dielectric layer 732, a via wall of the conductive via 732a may be conductive, and the conductive via 732a may transmit a signal. The conductive vias 732a may be arranged in a ring shape. In a thickness direction of the second dielectric layer 732, a ring formed by the conductive vias 732a may overlap the ring formed by the conductive vias 731a. One conductive via 732a may be correspondingly in communication with and electrically connected to one conductive via 731a. In this embodiment, the entire antenna element 7 may be manufactured into a multilayer PCB, and the conductive via 732a and the conductive via 731a are vias provided at different layers.

As shown in FIG. 37a, the ground plane 734 may be located on a side that is of the second dielectric layer 732 and that faces away from the third dielectric layer 731. The ground plane 734 is made of a conductive material, for example, a metal material.

Refer to FIG. 37a. The conductive via 731a may be electrically connected to the conductive layer 713, and the conductive via 732a may be electrically connected to the ground plane 734. Therefore, the conductive layer 713, the conductive via 731a, the conductive via 732a, and the ground plane 734 may form an equivalent cavity.

The feed structure 73 in this embodiment may be a strip line feed structure. The conductive layer 713 may serve as an upper ground plane of the feed structure 73, the ground plane 734 may serve as a lower ground plane of the feed structure 73, and the feed line 733 is located between the upper ground plane and the lower ground plane. A port of the feed structure 73 may pass through the ground plane 734, and is connected to an external connector, so that the feed structure 73 is electrically connected to the feed network.

FIG. 41 shows a relationship among the conductive layer 713, the third dielectric layer 731, the feed line 733, the second dielectric layer 732, and the ground plane 734 by using a local top view. The third dielectric layer 731 and the second dielectric layer 732 are both blocked by the conductive layer 713, and the first feed line 733a, the second feed line 733b, the conductive via 731a, and the conductive via 732a are all represented by using dashed lines.

As shown in FIG. 41, the conductive vias 731a and the conductive vias 732a surround an outer periphery of the first coupling slot 713a, the second coupling slot 713b, the first feed line 733a, and the second feed line 733b. As described above, the conductive layer 713, the conductive via 731a, the conductive via 732a, and the ground plane 734 may form an equivalent cavity, and the equivalent cavity encloses the first coupling slot 713a, the second coupling slot 713b, the first feed line 733a, and the second feed line 733b. The equivalent cavity can reduce backward radiation of the feed structure (that is, radiation in a direction facing away from the radiative metasurface 72), and can further reduce mutual coupling between feed structures of different antenna elements 7. It may be understood that the equivalent cavity may be canceled, that is, the third dielectric layer 731, the conductive via 731a in the third dielectric layer 731, and the conductive via 732a in the second dielectric layer 732 may not be provided. In addition, from an angle of view of FIG. 41, the first feed line 733a overlaps two disconnected parts of the first coupling slot 713a (or in other words, the first feed line 733a passes through the two parts), and the second feed line 733b overlaps the second coupling slot 713b (or in other words, the second feed line 733b passes through the second coupling slot 713b).

In Embodiment 4, for example, the antenna element 7 may be manufactured by using a PCB process, and the entire antenna element 7 may be a PCB. For example, a relative dielectric constant of each dielectric layer may be 3.55, and a loss tangent angle may be 0.0027. A thickness of the first dielectric layer 712 may be 2.5 mm, a thickness of the third dielectric layer 731 may be 0.71 mm, a thickness of the second dielectric layer 732 may be 1.524 mm, and a surface area (an area of a surface perpendicular to a thickness direction) of each dielectric layer may be 30 mm*80 mm. A surface area (an area of a surface perpendicular to the thickness direction) of the radiative metasurface 72 may be 24 mm*72 mm.

The following describes an operating principle and a characteristic of the antenna element 7.

With reference to FIG. 37a, the feed structure 73 may receive, through two ports, a feed signal transmitted by the feed network, the first feed line 733a may excite the first coupling slot 713a, and the second feed line 733b may excite the second coupling slot 713b. The first coupling slot 713a may couple a signal to a slot that is in the radiative metasurface 72 and that is parallel to the first coupling slot 713a, to implement +45° polarization radiation. The second coupling slot 713b may couple a signal to a slot that is in the radiative metasurface 72 and that is parallel to the second coupling slot 713b, to implement −45° polarization radiation. Therefore, the antenna element 7 can implement +45° dual-polarized radiation. It may be understood that, when only one port of the feed structure 73 is excited, one feed line in the feed structure 73 may excite one polarization, so that the antenna element 7 can implement single-polarized radiation (for example, +45° polarization or −45° polarization). When the antenna element 7 operates, the first gap and the second gap in the radiating structure radiate an electromagnetic wave.

In the solution of Embodiment 4, the first gap between the radiative metasurface 72 and the first conductive structure may be designed to adjust and control cross polarization discrimination of the asymmetric antenna element 7, so that the antenna element 7 has good cross polarization discrimination, and radiation performance is improved. It should be noted that the solutions in embodiments of this application can also improve cross polarization discrimination for the symmetric antenna element (the first size d1 is equal to the second size d2). Therefore, the solutions in embodiments of this application may be applied to the asymmetric antenna and the symmetric antenna. The notch provided on the conductive frame 711 and the notch provided on the “annular pattern” formed by all the second conductive vias 712a may avoid other components (for example, a connecting piece such as a screw) in the antenna element 7, to facilitate mounting of these components.

In addition, the solution in Embodiment 4 can also implement a low-profile broadband antenna; independently adjust and control beam widths in the horizontal direction and the vertical direction, to improve an antenna gain, simplify the feed network, and improve overall efficiency of the antenna system; implement a horizontal-direction antenna array design; and implement an antenna self-decoupling function, to improve isolation between antenna elements in a compact antenna array, reduce distortion of the radiation pattern, and improve wireless network performance.

FIG. 41 shows a design of an equivalent cavity, a coupling slot, and a feed line according to Embodiment 4. The following describes a plurality of solutions different from that shown in FIG. 41.

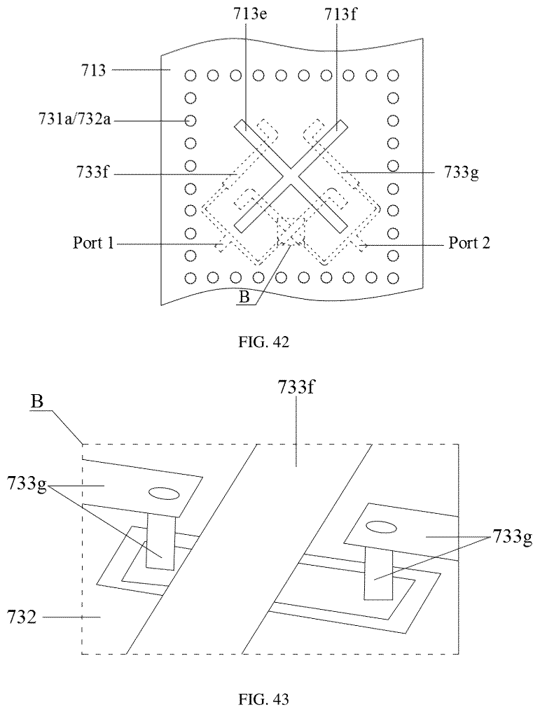

FIG. 42 is a top view of a partial structure of a feed structure according to an embodiment. Comparing FIG. 42 with FIG. 41, a difference from Embodiment 4 is that a first coupling slot 713ein this embodiment may have no arrow structure, and the first coupling slot 713emay be continuous without interruption. Both the first coupling slot 713eand a second coupling slot 713fmay be orthogonal and in communication. By using an intersection as a boundary, the first coupling slot 713emay be divided into a first part and a second part, where the first part and the second part may be collinear; and the second coupling slot 713fmay be divided into a third part and a fourth part, where the third part and the fourth part may be collinear. A structure of a first feed line 733fmay be basically consistent with that of a second feed line 733g. Both the first feed line 733fand the second feed line 733g may have symmetric structures, and positions of the first feed line 733fand the second feed line 733g may be symmetric. The first feed line 733fmay overlap the first coupling slot 713ein two places, and the second feed line 733g may overlap the second coupling slot 713fin two places. Both a port Port1 of the first feed line 733fand a port Port2 of the second feed line 733g may be located in the ring formed by the conductive vias 731a (or the conductive vias 732a), that is, the entire feed line may be located in the equivalent cavity, so that isolation of ±45° polarization is good.

As shown in FIG. 42 and FIG. 43, the first feed line 733fand the second feed line 733g may overlap, and a bridge transition structure may be used in an overlapping area of the first feed line 733fand the second feed line 733g, to avoid direct contact between the first feed line 733f and the second feed line 733g. As shown in FIG. 43, for example, a part of the second feed line 733g may be disposed at an inner layer of the second dielectric layer 732 to be isolated from the first feed line 733fdisposed at a surface layer of the second dielectric layer 732. Such a structure may be referred to as the bridge transition structure.

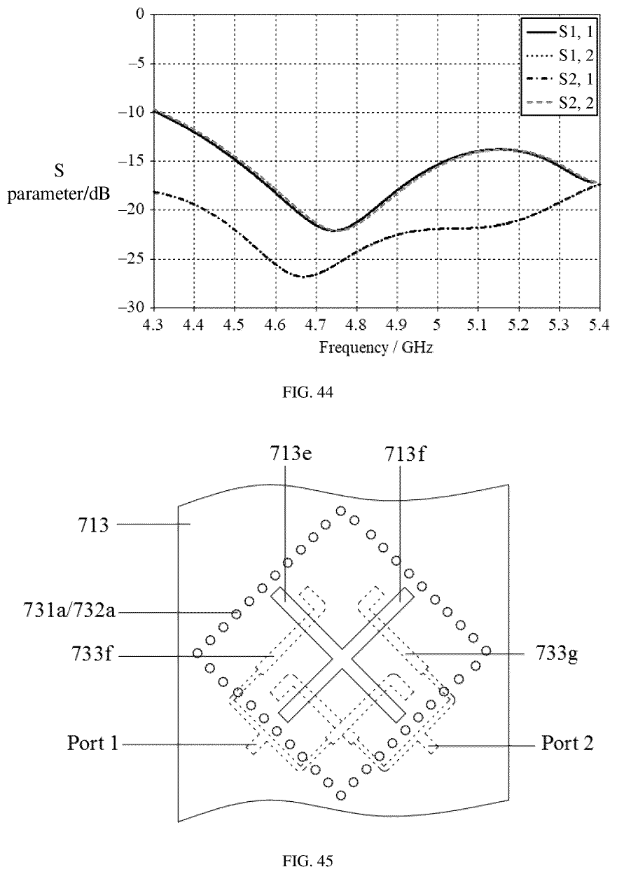

The feed structure shown in FIG. 42 and FIG. 43 has a symmetric structure, and can effectively improve polarization isolation of the antenna element. For example, as shown in FIG. 44, polarization isolation of the antenna element may be greater than 20 dB.

FIG. 45is a local top view of a feed structure according to another embodiment. Comparing FIG. 45with FIG. 42, a difference from the embodiment shown in FIG. 42 is that a ring formed by the conductive vias 731a (or the conductive vias 732a) in FIG. 45may be rotated by a specific angle and is in an “upright” form, so that both the port Port1 and the port Port2 are located outside the ring. This design enables a part of a feed line to be outside the equivalent cavity, so that cabling in the equivalent cavity may be simple, cabling space in the equivalent cavity is wide, and impact of the feed line on antenna performance can be reduced.

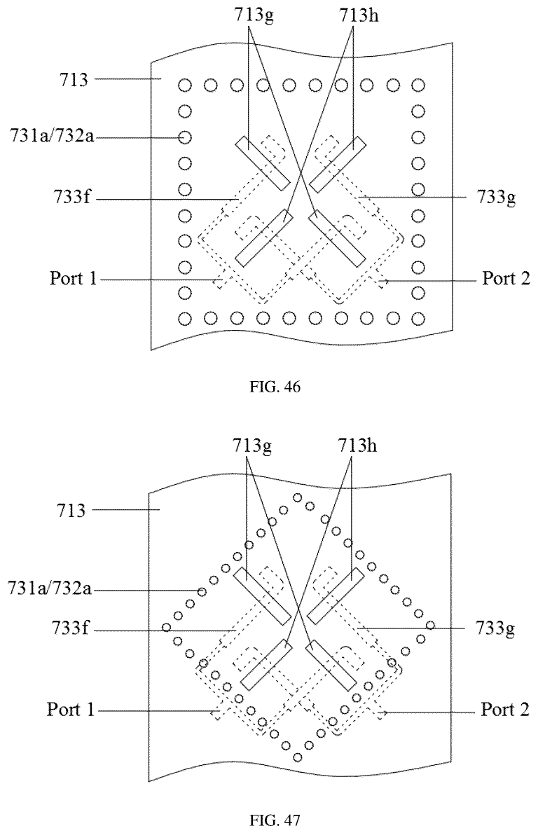

FIG. 46 is a local top view of a feed structure according to another embodiment. Comparing FIG. 46 with FIG. 42, a difference from the embodiment shown in FIG. 42 is that a first coupling slot 713g in FIG. 46 may include a first part and a second part that are disconnected, and the two parts may be collinear but not in communication. A second coupling slot 713h in FIG. 46 may include a third part and a fourth part that are disconnected, and the two parts may be collinear but not in communication. In addition, the first coupling slot 713g may not be in communication with the second coupling slot 713h. A part of the first feed line 733foverlaps the first part, and the other part of the first feed line 733foverlaps the second part. Because the first part and the second part are disconnected, each part of the first feed line 733f(for example, +45° polarization may be excited) affects only a part of the first coupling slot 713g, which can reduce impact on radiation in another polarization direction (for example, −45° polarization direction). A part of the second feed line 733g overlaps the third part, and the other part of the second feed line 733g overlaps the fourth part. Because the third part and the fourth part are disconnected, each part of the second feed line 733g (for example, −45° polarization may be excited) affects only a part of the second coupling slot 713h, which can reduce impact on radiation in another polarization direction (for example, +45° polarization direction).

FIG. 47 is a local top view of a feed structure according to another embodiment. Comparing FIG. 47 with FIG. 46, a difference from the embodiment shown in FIG. 46 is that a ring formed by the conductive vias 731a (or the conductive vias 732a) in FIG. 47 may be rotated by a specific angle and is in an “upright” form, so that both the port Port1 and the port Port2 are located outside the ring. This design enables a part of a feed line to be outside the equivalent cavity, so that cabling in the equivalent cavity may be simple, cabling space in the equivalent cavity is wide, and impact of the feed line on antenna performance can be reduced.

The feed structure shown in FIG. 41 to FIG. 47 belongs to a slot-coupled feed structure, and uses the first coupling slot and the second coupling slot. In another embodiment, the slot feed structure may alternatively be replaced with another feed structure, for example, the foregoing probe feed structure, dipole feed structure, or patch feed structure. Correspondingly, the coupling slot on the conductive layer 713 may be canceled, and the feed structure (for example, a probe, a dipole, or a patch) is disposed in the first dielectric layer 712. The feed structure is coupled to the radiating structure. A port of the feed structure may be connected to an external connector (for example, an SMA connector) by passing through the conductive layer 713, so that the feed structure is electrically connected to the feed network.

In the embodiments corresponding to FIG. 36 to FIG. 47, each dielectric layer is a physical structure. Based on any one of the foregoing embodiments, any one of the physical material dielectric layers may be replaced with air. It may be understood that designs of the dielectric layers are independent of each other and do not affect each other. A plurality of embodiments are listed below.

In an embodiment, different from that shown in FIG. 37a, the first dielectric layer 712 may be air. The second conductive via 712a may be replaced with a second conductive column, and each second conductive column is connected between the conductive frame 711 and the conductive layer 713. The second conductive via 712a may be replaced with a second support column, and each second support column may be connected between one conductive unit and the conductive layer. Any second support column may be conductive to electrically connect a corresponding conductive unit to the conductive layer; or the second support column may be an insulator, and the second support column only plays a mechanical support role.

In an embodiment, different from that shown in FIG. 37a, the third dielectric layer 731 may be air. The conductive via 731a may be replaced with a conductive column, one end of the conductive column is connected to the conductive layer 713, and the other end of the conductive column is electrically connected to the conductive via 732a.

In an embodiment, different from that shown in FIG. 37a, the second dielectric layer 732 may be air. The conductive via 732a may be replaced with a conductive column, one end of the conductive column is connected to the conductive via 731a, and the other end of the conductive column is electrically connected to the ground plane 734. In this embodiment, the third dielectric layer 731 may be a physical material layer, and the feed line 733 is made on a lower surface of the third dielectric layer 731.

In an embodiment, different from that shown in FIG. 37a, both the third dielectric layer 731 and the second dielectric layer 732 may be air. Both the conductive via 731a and the conductive via 732a may be replaced with conductive columns, and the two conductive columns may be assembled together or connected together. The two conductive columns are connected. In this embodiment, an insulated mechanical part may be connected between the conductive layer 713 and the ground plane 734, and the feed line 733 is fastened by using the insulated mechanical part.

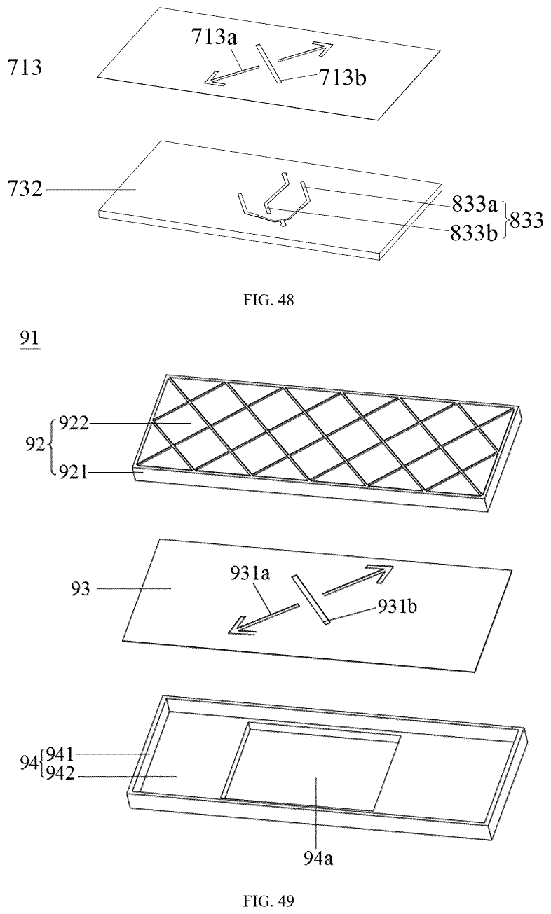

Different from Embodiment 4, as shown in FIG. 48, the feed structure in Embodiment 5 may be a microstrip feed structure (also belong to a slot feed structure). Compared with the strip line feed structure shown in FIG. 37a, the microstrip feed structure shown in FIG. 48 may not include the third dielectric layer 731 and the conductive via 731a in the third dielectric layer 731, or may not include the ground plane 734, and the second dielectric layer 732 may not be provided with the conductive via 732a. A structure of a feed line 833 in FIG. 48 may be the same as or different from the structure of the feed line 733 in FIG. 37a. A first feed line 833a may be configured to excite the first coupling slot 713a, and a second feed line 833b may be configured to excite the second coupling slot 713b. The feed structure in Embodiment 5 is simple, and may be used based on a product requirement.

In the solution of Embodiment 5, cross polarization discrimination of the antenna element may be adjusted and controlled, so that the antenna element has good cross polarization discrimination. This can implement a low-profile broadband antenna; independently adjust and control beam widths in the horizontal direction and the vertical direction, to improve an antenna gain, simplify the feed network, and improve overall efficiency of the antenna system; implement a horizontal-direction antenna array design; and implement an antenna self-decoupling function, to improve isolation between antenna elements in a compact antenna array, reduce distortion of the radiation pattern, and improve wireless network performance.

It may be understood that, based on the solution in Embodiment 5, any physical material dielectric layer may also be replaced with air, and other structures are correspondingly designed. Details are not described herein again.

The foregoing embodiment describes the antenna element combining the equivalent back cavity and the slot feed structure. Different from the foregoing embodiment, the following embodiment describes an antenna element combining a physical back cavity and a slot feed structure.

FIG. 49 shows a radiating structure 91 of an antenna element according to Embodiment 6. The antenna element may use the foregoing slot feed structure (for example, the strip line feed structure or the microstrip feed structure). To highlight a key feature, the slot feed structure is not shown in FIG. 49.

As shown in FIG. 49, the radiating structure 91 may include a radiative metasurface structure 92, a ground plane 93, and a conductive frame body 94.

The radiative metasurface structure 92 may include a first dielectric layer 921 and a radiative metasurface 922 born on the first dielectric layer 921. The first dielectric layer 921 may be a physical material layer.

The ground plane 93 and the first dielectric layer 921 may be stacked, and the ground plane 93 is located on a side that is of the first dielectric layer 921 and that faces away from the radiative metasurface 922. A first coupling slot 931a and a second coupling slot 931b may be provided on the ground plane 93. The ground plane 93 may serve as a ground plane of the radiating structure 91, and may also serve as a ground plane of the slot feed structure.

The conductive frame body 94 may serve as a physical back cavity. The conductive frame body 94 may include a first conductive structure 941 (that is, a peripheral side wall) and a conductive layer 942 (that is, a bottom wall).

As described above, the first conductive structure 941 may surround an edge of the conductive layer 942 once; or at least one notch may be provided at any position of the first conductive structure 941 and/or any side of the first conductive structure 941 may be removed, and the first conductive structure 941 may surround a part of the edge of the conductive layer 942. For example, the following continues to provide descriptions by using an example in which the first conductive structure 941 surrounds the edge of the conductive layer 942 once and is provided with no notch.

A through hole 94a may be provided on the conductive layer 942. The conductive layer 942 may be in contact with the ground plane 93 (there may be an assembly gap between the conductive layer 942 and the ground plane 93). In a direction perpendicular to the bottom wall, projections of both the first coupling slot 931a and the second coupling slot 931b may fall into the through hole 94a. It should be noted that, different from the embodiment shown in FIG. 37a, the ground plane 93 and the conductive layer 942 in this embodiment are no longer combined into one.

As described above, the feed structure in Embodiment 6 may be a strip line feed structure or a microstrip feed structure. When the strip line feed structure is used, with reference to FIG. 37a and FIG. 49, the second dielectric layer, the feed line, and the lower ground plane may be disposed outside the conductive frame body 94, and the feed line is located in an area of the through hole 94a, so that the feed line may excite the coupling slot. When the microstrip feed structure is used, with reference to FIG. 48 and FIG. 49, the second dielectric layer and the feed line may be disposed outside the conductive frame body 94, and the feed line is located in an area of the through hole 94a, so that the feed line may excite the coupling slot.

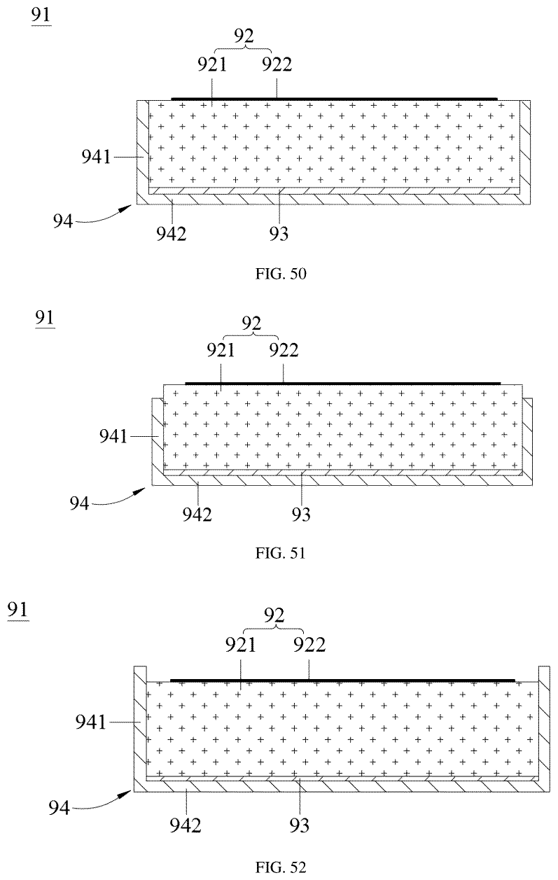

FIG. 50, FIG. 51, and FIG. 52 show assembled structures of the radiating structure 91 in different implementations of Embodiment 6 by using sectional views. Internal space of the first conductive structure 941 may be filled with the radiative metasurface structure 92 and the ground plane 93. A difference is that the radiative metasurface 922 may be basically flush with a top surface of the first conductive structure 941 (as shown in FIG. 50), or higher than the top surface of the first conductive structure 941 (as shown in FIG. 51), or lower than the top surface of the first conductive structure 941 (as shown in FIG. 52). In the foregoing design, sizes of first gaps between the radiative metasurface 922 and the first conductive structure 941 may be different, and cross polarization discrimination of the antenna may be adjusted by designing the first gaps with different sizes, to meet a product requirement.

In the solution of Embodiment 6, cross polarization discrimination of the antenna element may be adjusted and controlled, so that the antenna element has good cross polarization discrimination. This can implement a low-profile broadband antenna; independently adjust and control beam widths in the horizontal direction and the vertical direction, to improve an antenna gain, simplify the feed network, and improve overall efficiency of the antenna system; implement a horizontal-direction antenna array design; and implement an antenna self-decoupling function, to improve isolation between antenna elements in a compact antenna array, reduce distortion of the radiation pattern, and improve wireless network performance.

Based on the solution in Embodiment 6, in another embodiment, the first dielectric layer 921 may be replaced with air, and other structures are correspondingly designed. A plurality of first support columns may be connected between the radiative metasurface 922 and the ground plane 93. Each conductive unit of the radiative metasurface 922 is connected to at least one first support column (to fully support a conductive unit, more than one first support column may be used to support the conductive unit), that is, a quantity of first support columns may be greater than or equal to a quantity of conductive units. To electrically connect a conductive unit to the ground plane 93, a first support column connected to the conductive unit may have conductive performance. The conductive unit is electrically connected to the ground plane 93, so that an antenna gain can be increased and isolation can be increased. It may be understood that a design of electrically connecting the conductive unit to the ground plane 93 is not necessary.

In any embodiment of this application, the conductive layer of the back cavity (including the physical back cavity and the equivalent back cavity) may be complete without providing a hole, and the conductive layer independently serves as a bottom wall of the back cavity. Alternatively, the conductive layer may be partially hollowed out, and the partially hollowed-out conductive layer and a conductive component below the partially hollowed-out conductive layer may jointly serve as a bottom wall of the back cavity. A hollow-out shape includes but is not limited to the first coupling slot 713a and the second coupling slot 713b that are provided on the conductive layer 713 shown in FIG. 37a, and the through hole 94a that is provided on the conductive layer 942 shown in FIG. 49, or may be any shape that meets a product requirement.

In embodiments of this application, the terms “first”, “second”, “third”, and the like are merely used to distinguish between components, and cannot be understood as indication or implication of relative importance of components or implicitly indication of a quantity of indicated technical features. Therefore, a feature defined by “first”, “second”, or the like, may explicitly or implicitly include one or more features. In the descriptions of embodiments of this application, unless otherwise specified, “a plurality of (layers)” means two (layers) or more (layers).

In embodiments of this application, “a plurality of” means two or more.

In embodiments of this application, the terms such as “up”, “down”, “front”, “front side”, “back”, and “back side” are defined with respect to a position of a schematic structural placement in the accompanying drawings. It should be understood that these directional terms are relative concepts, are relative descriptions and clarifications, and may change accordingly based on a change of a position of a structure.

In embodiments of this application, unless otherwise specified, “and/or” is merely an association relationship for describing an associated object, and represents that three relationships may exist. For example, A and/or B may represent the following three cases: Only A exists alone, both A and B exist, and only B exists.

The foregoing describes embodiments of this application in detail. Specific examples are used in this specification to describe the principle and embodiments of this application. The descriptions of the foregoing embodiments are merely intended to help understand the method and the core idea of this application. In addition, a person of ordinary skill in the art may make modifications to the specific embodiments and an application range according to the idea of this application. Therefore, the content of this specification shall not be construed as a limitation to this application.

1. An antenna element, wherein
the antenna element comprises a radiating structure, wherein the radiating structure comprises a first conductive structure, a conductive layer, and a radiative metasurface, the first conductive structure surrounds at least a part of an edge of the conductive layer and is connected to the conductive layer, the radiative metasurface and the conductive layer are stacked, the radiative metasurface is located on a side that is of the first conductive structure and that faces away from the conductive layer, there is a first gap between the radiative metasurface and the first conductive structure, the radiative metasurface comprises a plurality of conductive units, and there is a second gap between every two adjacent conductive units.

2. The antenna element according to claim 1, wherein
the first conductive structure surrounds the edge of the conductive layer once.

3. The antenna element according to claim 1, wherein
the first conductive structure is provided with at least one notch.

4. The antenna element according to claim 1, wherein
the antenna element comprises a first dielectric layer, the first dielectric layer and the conductive layer are stacked, the first conductive structure is in contact with the first dielectric layer, or the first conductive structure is disposed in the first dielectric layer, and the radiative metasurface is located on a surface of the first dielectric layer, or the radiative metasurface is embedded in the first dielectric layer.

5. The antenna element according to claim 4, wherein
the first dielectric layer is a physical material layer.

6. The antenna element according to claim 5, wherein
the first conductive structure and the conductive layer are connected to form a conductive frame body, the first conductive structure is a peripheral side wall of the conductive frame body, and the first dielectric layer is mounted on the first conductive structure.

7. The antenna element according to claim 6, wherein
the first dielectric layer is located at an inner periphery of the first conductive structure, or the first dielectric layer is mounted at an end that is of the first conductive structure and that faces away from the conductive layer.

8. The antenna element according to claim 6, wherein
the radiative metasurface is located on a surface that is of the first dielectric layer and that faces away from the conductive layer, or the radiative metasurface is embedded in the first dielectric layer, the plurality of conductive units comprise a first conductive unit, a first conductive via is provided in the first dielectric layer, the first conductive via is electrically connected to the first conductive unit, the radiating structure comprises a first conductive column, the first conductive column is located between the first dielectric layer and the conductive layer, and the first conductive column is electrically connected to both the first conductive via and the conductive layer; or
the radiative metasurface is located on a surface that is of the first dielectric layer and that faces the conductive layer, the plurality of conductive units comprise a first conductive unit, the radiating structure comprises a first conductive column, the first conductive column is located between the radiative metasurface and the conductive layer, and the first conductive column is electrically connected to both the first conductive unit and the conductive layer.

9. The antenna element according to claim 8, wherein
the plurality of conductive units comprise a plurality of edge conductive units and a plurality of internal conductive units, the plurality of edge conductive units surround an outer periphery of the plurality of internal conductive units, and the first conductive unit is the internal conductive unit.

10. The antenna element according to claim 5, wherein
the radiating structure comprises a conductive frame, the conductive frame and the conductive layer are respectively located on two opposite sides of the first dielectric layer, the conductive frame surrounds at least a part of an edge of the radiative metasurface, there is a gap between the conductive frame and the radiative metasurface, the first conductive structure comprises a plurality of second conductive vias formed in the first dielectric layer, and each second conductive via is electrically connected between the conductive frame and the conductive layer.

11. The antenna element according to claim 10, wherein
a third conductive via is provided in the first dielectric layer, the plurality of conductive units comprise a first conductive unit, and the first conductive unit is electrically connected to the conductive layer through the third conductive via.

12. The antenna element according to claim 11, wherein
the plurality of conductive units comprise a plurality of edge conductive units and a plurality of internal conductive units, the plurality of edge conductive units surround an outer periphery of the plurality of internal conductive units, and the first conductive unit is the internal conductive unit.

13. The antenna element according to claim 4, wherein
the first dielectric layer is air.

14. The antenna element according to claim 13, wherein
the first conductive structure and the conductive layer are connected to form a conductive frame body, the first conductive structure is a peripheral side wall of the conductive frame body, the radiating structure comprises a plurality of first support columns, each first support column is located between one conductive unit and the conductive layer, and each conductive unit is connected to at least one first support column.

15. The antenna element according to claim 14, wherein
the radiating structure comprises a ground plane, the ground plane is located between the radiative metasurface and the conductive layer, and the ground plane has a coupling slot;
the conductive layer has a through hole, an orthographic projection of the coupling slot on the conductive layer falls into the through hole, the antenna element comprises a feed structure, the feed structure is located outside the conductive frame body, and an orthographic projection of the feed structure on the conductive layer falls into the through hole; and
each first support column is connected between one conductive unit and the ground plane.

16. The antenna element according to claim 14, wherein
at least one of the plurality of first support columns is conductive.

17. The antenna element according to claim 16, wherein
the plurality of conductive units comprise a plurality of edge conductive units and a plurality of internal conductive units, the plurality of edge conductive units surround an outer periphery of the plurality of internal conductive units, and at least one internal conductive unit is connected to the first support column that is conductive.

18. The antenna element according to claim 13, wherein
the radiating structure comprises a conductive frame and a plurality of second support columns, the conductive frame surrounds an outer periphery of the radiative metasurface, there is a gap between the conductive frame and the radiative metasurface, each second support column is connected between one conductive unit and the conductive layer, and each conductive unit is connected to at least one second support column; and
the first conductive structure comprises a plurality of second conductive columns that are spaced in sequence, and each second conductive column is connected between the conductive frame and the conductive layer.

19. The antenna element according to claim 18, wherein
at least one of the plurality of second support columns is conductive.

20. The antenna element according to claim 19, wherein
the plurality of conductive units comprise a plurality of edge conductive units and a plurality of internal conductive units, the plurality of edge conductive units surround an outer periphery of the plurality of internal conductive units, and at least one internal conductive unit is connected to the second support column that is conductive.
